(19) United States
(12) Patent Application Publication
(10) Pub. No.: US 2026/0084988 A1
(43) Pub. Date: Mar. 26, 2026

(54) WATER TREATMENT APPARATUS AND METHOD FOR CONTROLLING THE SAME

(71) Applicant: SAMSUNG ELECTRONICS CO., LTD., Suwon-si (KR)

(72) Inventors: Jungha PARK, Suwon-si (KR); Gimum Gwak, Suwon-si (KR); Keonpyo Koo, Suwon-si (KR); Hyeonho Lee, Suwon-si (KR); Hyunjun Chung, Suwon-si (KR)

(73) Assignee: SAMSUNG ELECTRONICS CO., LTD., Suwon-si (KR)

(21) Appl. No.: 19/383,129

(22) Filed: Nov. 7, 2025

Related U.S. Application Data
(63) Continuation of application No. PCT/KR2025/095596, filed on Sep. 22, 2025.

(30) Foreign Application Priority Data
Sep. 26, 2024 (KR) 10-2024-0130657

(51) Int. Cl. C02F 1/469; C02F 101/10

(52) U.S. Cl. CPC C02F 1/4693; C02F 1/4691; C02F 2101/10; C02F 2201/005; C02F 2209/40

(57) ABSTRACT

A water treatment apparatus, includes a first electrode module, including a plurality of first electrodes, a second electrode module adjacent to a first side of the first electrode module, and including a plurality of second electrodes, a water supply flow path, and a valve configured to switch a direction of water, supplied through the water supply flow path, from the water supply path to a second side, opposite to the first side of the first electrode module, and from the water supply path to a first side of the second electrode module.

### CROSS-REFERENCE TO RELATED APPLICATIONS

This application is a continuation of International Application No. PCT/KR2025/095596, filed on Sep. 22, 2025, which is based on and claims priority to Korean Patent Application No. 10-2024-0130657, filed on Sep. 26, 2024, in the Korean Intellectual Property Office, the disclosures of which are incorporated by reference herein in their entireties.

### BACKGROUND

### 1. Field

The disclosure relates to a water treatment apparatus using electrochemical deionization technology, and a method for controlling the same.

### 2. Description of Related Art

Deionization is a technology widely used across industries to remove hardness components such as calcium and magnesium from high hardness water, for use as drinking water, boiler water, or cooling water in power plants and factories.

In electrochemical deionization, ions are removed by electrochemical adsorption on electrodes. Examples of the electrochemical deionization technology include electrodialysis (ED), electrodeionization (EDI), and capacitive deionization (CDI).

With the electrochemical deionization technology, purified water free of ions contained in external water may be produced by forming an electric field through electrodes contained in a filter to move and remove ions.

In the electrochemical deionization technology, a plurality of electrodes may be used to produce purified water from which ions in water have been removed by passing through the plurality of electrodes, resulting in an increased deionization efficiency.

### SUMMARY

The disclosure provides a water treatment apparatus including a plurality of electrode modules and capable of switching a direction of water passing through the plurality of electrode modules, and a method for controlling the same.

The disclosure provides a water treatment apparatus that may supply different power to each of a plurality of electrode modules, and method for controlling the same.

Technical aspects that can be achieved by the disclosure are not limited to the above-mentioned aspects, and other technical aspects not mentioned will be clearly understood by one of ordinary skill in the technical art to which the disclosure belongs from the following description.

According to an aspect of the disclosure, a water treatment apparatus includes: a first electrode module including a plurality of first electrodes; a second electrode module arranged adjacent to a first side of the first electrode module and including a plurality of second electrodes and; a water supply flow path; and a valve configured to switch a direction of water, supplied through the water supply flow path, from the water supply path to a second side, opposite to the first side of the first electrode module, and from the water supply path to a first side of the second electrode module.

The water treatment apparatus may further include a housing accommodating the first electrode module and the second electrode module, and the housing includes a first opening, provided on the second side of the first electrode module, and a second opening provided on the first side of the second electrode module.

The water treatment apparatus may further include: a first guide flow path configured to guide the water, supplied through the water supply flow path, to the first opening; and a second guide flow path configured to guide the water, supplied through the water supply flow path, to the second opening, and the valve may be further configured to: switch the direction of the water, supplied through the water supply flow path, to the second side of the first electrode module by connecting the water supply flow path and the first guide flow path and blocking the second guide flow path, and switch the direction of the water, supplied through the water supply flow path, to the first side of the second electrode module by connecting the water supply flow path and the second guide flow path and blocking the first guide flow path.

The water treatment apparatus may further include at least one electrode terminal between the first electrode module and the second electrode module inside the housing.

The water treatment apparatus may further include: a first housing accommodating the first electrode module; and a second housing accommodating the second electrode module, and the first housing includes a first housing opening, provided on the second side of the first electrode module, and a first housing connection opening on the first side of the first electrode module, and the second housing includes a second housing opening on the first side of the second electrode module, and a second housing connection opening on the second side of the second electrode module.

The water treatment apparatus may further include a first guide flow path configured to guide the water, supplied through the water supply flow path, to the first housing opening; a second guide flow path configured to guide the water, supplied through the water supply flow path, to the second housing opening; and an intermediate flow path configured to connect the first housing connection opening and the second housing connection opening, and the valve may be further configured to: switch the direction of the water, supplied through the water supply flow path, from the water supply flow path to the second side of the first electrode module by connecting the water supply flow path, and the first guide flow path and blocking the second guide flow path, and switch the direction of the water, supplied through the water supply flow path, from the water supply flow path to the first side of the second electrode module by connecting the water supply flow path and the second guide flow path and blocking the first guide flow path.

The water treatment apparatus may further include a storage compartment connected to the water supply flow path and configured to store a descaling agent, and the valve may be further configured to switch the direction of the water supplied through the water supply flow path to any of the first electrode module and the second electrode module from from the storage compartment and to bypass the storage compartment.

The water treatment apparatus may further include a controller configured to control the valve based on at least one of a concentration of the water supplied through the water supply flow path and a flow rate of the water supplied through the water supply flow path.

The controller may be further configured to: control, in a state in which the direction of the water supplied through the water supply flow path is toward the second side of the first electrode module, the valve to switch the direction of the water, supplied through the water supply flow path, to the first side of the second electrode module, based on the concentration of the water supplied through the water supply flow path being greater than or equal to a reference concentration.

The controller may be further configured to: control, in a state in which the direction of the water supplied through the water supply flow path is toward the second side of the first electrode module, the valve to switch the direction of the water, supplied through the water supply flow path, to the first side of the second electrode module, based on the flow rate of the water supplied through the water supply flow path being greater than or equal to a reference flow rate.

The water treatment apparatus may further include a controller configured to control the valve based on at least one of a concentration of the water that has passed through the first electrode module and the second electrode module and a flow rate of the water that has passed through the first electrode module and the second electrode module.

The controller may be further configured to,, in a state in which the direction of water supplied through the water supply flow path is toward the second side of the first electrode module: control the valve to switch the direction of the water, supplied through the water supply flow path, to the first side of the second electrode module, based on the concentration of the water that has passed through the first electrode module and the second electrode module being greater than or equal to a reference concentration, and control, in the state in which the direction of water supplied through the water supply flow path is toward the second side of the first electrode module, the valve to switch the direction of the water, supplied through the water supply flow path, to the first side of the second electrode module, based on the flow rate of the water that has passed through the first electrode module and the second electrode module being greater than or equal to a reference flow rate.

The water treatment apparatus may further include a controller configured to supply a first power to the first electrode module and supply a second power to the second electrode module, based on the direction of the water supplied through the water supply flow path being from the water supply path to the second side of the first electrode module, and supply a third power to the first electrode module and supply a fourth power to the second electrode module, based on the direction of the water supplied through the water supply flow path being from the water supply path to the first side of the second electrode module, and a magnitude of the first power is larger than a magnitude of the second power, and a magnitude of the third power is smaller than a magnitude of the fourth power.

The water treatment apparatus may further include a controller configured to supply a first power to the first electrode module and supply a second power to the second electrode module, respectively, based on the direction of the water supplied through the water supply flow path being from the water supply path to the second side of the first electrode module, and supply a third power to the first electrode module and supply a fourth power to the second electrode module, respectively, based on the direction of the water supplied through the water supply flow path being from the water supply path to the first side of the second electrode module, and a duty ratio of the first power is greater than a duty ratio of the second power, and a duty ratio of the third power is less than a duty ratio of the fourth power.

According to an aspect, a water treatment apparatus, includes: a first electrode module comprising a plurality of first electrodes; a second electrode module adjacent to a first side of the first electrode module and comprising a plurality of second electrodes; a water supply flow path; a power supply configured to supply a first power to the first electrode module and supply a second power to the second electrode module; a valve; and a controller, and the controller is configured to, in a state in which a direction of water supplied through the water supply flow path is toward a second side opposite to the first side of the first electrode module: switch the direction of water, supplied through the water supply flow path, to a first side of the second electrode module, or adjust the first power supplied to the first electrode module.

According to an aspect, there is water treatment apparatus including: a first electrode module comprising a plurality of first electrodes; a second electrode module adjacent to a first side of the first electrode module and comprising a plurality of second electrodes; a water supply flow path; a power supply configured to supply a first power and a second power to the first electrode module and the second electrode module, respectively; a valve; and a controller configured to, in a state in which a direction of water supplied through the water supply flow path is toward a second side opposite to the first side of the first electrode module: switch the direction of water, supplied through the water supply flow path, from the water supply flow path to a first side of the second electrode module, and adjust the first power supplied to the first electrode module.

The controller may be further configured to, in a state in which the direction of water supplied through the water supply flow path is toward the second side of the first electrode module, increase at least one of a magnitude or a duty ratio of a first power supplied to the first electrode module, based on a concentration of water supplied through the water supply flow path being greater than or equal to a reference concentration.

The controller may be further configured to, in a state in which the direction of water supplied through the water supply flow path is toward the second side of the first electrode module, increase at least one of a magnitude or a duty ratio of a first power supplied to the first electrode module, based on a flow rate of water supplied through the water supply flow path being greater than or equal to a reference flow rate.

The controller may be further configured to: in a state in which the direction of water supplied through the water supply flow path is toward the second side of the first electrode module, increase at least one of a magnitude or a duty ratio of a first power supplied to the first electrode module, based on a concentration of water that has passed through the first electrode module and the second electrode module being greater than or equal to a reference concentration, and in a state in which the direction of water supplied through the water supply flow path is toward the second side of the first electrode module, increase at least one of a magnitude or a duty ratio of a first power supplied to the first electrode module, based on a flow rate of water that has passed through the first electrode module and the second electrode module being greater than or equal to a reference flow rate.

According to an aspect, there is provided a method for controlling a water treatment apparatus including a first electrode module including a plurality of first electrodes, a second electrode module including arranged adjacent to a first side of the first electrode module and a plurality of second electrodes; a water supply flow path, and a valve configured to switch a direction of water supplied through the water supply flow path, the method including: controlling the valve to switch the direction of water supplied through the water supply flow path, from the water supply path to a second side, opposite to the first side of the first electrode module; and controlling the valve to switch the direction of water supplied through the water supply flow path, from the water supply path to a first side of the second electrode module, based on at least one of a concentration or a flow rate of water supplied through the water supply flow path.

According to one or more embodiments of the disclosure, a direction of water passing through a plurality of electrode modules may be switched to change an order in which the water passes through the plurality of electrode modules, thereby relatively increasing a lifespan of the plurality of electrode modules.

According to one or more embodiments of the disclosure, a magnitude and a duty ratio of power supplied to an electrode module to which water first flows among a plurality of electrode modules may be controlled, thereby increasing deionization efficiency.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a conceptual diagram illustrating an example of a water treatment apparatus according to one or more embodiments;

FIG. 2 is a control block diagram of a water treatment apparatus according to one or more embodiments;

FIG. 3 illustrates an example of a direction of water supplied from a water supply flow path of a water treatment apparatus according to one or more embodiments;

FIG. 4 illustrates an example different from FIG. 3 of a direction of water supplied from a water supply flow path of a water treatment apparatus according to one or more embodiments;

FIG. 5 illustrates an example in which water supplied from a water supply flow path of a water treatment apparatus passes through an electrode module according to one or more embodiments;

FIG. 6 illustrates an example, different from FIG. 5, in which water supplied from a water supply flow path of a water treatment apparatus passes through an electrode module according to one or more embodiments;

FIG. 7 illustrates an example in which water supplied from a water supply flow path passes through an electrode module of a water treatment apparatus according to another embodiment different from FIG. 5;

FIG. 8 illustrates an example, different from FIG. 7, in which water supplied from a water supply flow path passes through an electrode module of a water treatment apparatus according to another embodiment different from FIG. 5;

FIG. 9 is a schematic diagram illustrating an internal configuration of an electrode module according to one or more embodiments;

FIG. 10 is a diagram illustrating a deionization operation method by an electrode module according to one or more embodiments;

FIG. 11 is a diagram illustrating a regeneration operation method by an electrode module according to one or more embodiments;

FIG. 12 illustrates an example of a direction of water supplied through a water supply flow path of a water treatment apparatus according to one or more embodiments;

FIG. 13 illustrates an example different from FIG. 12 of a direction of water supplied through a water supply flow path of a water treatment apparatus according to one or more embodiments;

FIG. 14 is a flowchart illustrating an example of a method for controlling a water treatment apparatus according to one or more embodiments;

FIG. 15 is a flowchart illustrating an example of a method for controlling a water treatment apparatus according to one or more embodiments; and

FIG. 16 is a diagram illustrating an example of switching a direction of water supplied through a water supply flow path of a water treatment apparatus or supplying power to each of a plurality of electrode modules according to one or more embodiments.

### DETAILED DESCRIPTION

Various embodiments of the disclosure and terms used therein are not intended to limit the technical features described in the disclosure to particular embodiments, and it should be construed as including various modifications, equivalents, or alternatives of a corresponding embodiment.

With regard to description of drawings, similar reference numerals may be used for similar or related components.

A singular form of a noun corresponding to an item may include one item or a plurality of the items unless context clearly indicates otherwise.

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

The term “and/or” includes any and all combinations of one or more of a plurality of associated listed items.

Terms such as “portion”, “module”, and “member” may be embodied as hardware or software. According to embodiments, a plurality of “portions”, “modules”, and “members” may be implemented as a single component or a single “portion”, “module”, and “member”may include a plurality of components.

It will be understood that the terms “first”, “second”, etc., may be used only to distinguish one component from other components, not intended to limit the corresponding component in other aspects (e.g., importance or order).

It is said that one (e.g., first) component is “coupled” or “connected” to another (e.g., second) component, with or without the terms “functionally” or “communicatively”. When referenced, it means that one component can be connected to another component directly (e.g., by wire), wirelessly, or through a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

An expression that one component is “connected”, “coupled”, “supported”, or “in contact” with another component includes a case in which the components are directly “connected”, “coupled”, “supported”, or “in contact” with each other and a case in which the components are indirectly “connected”, “coupled”, “supported”, or “in contact” with each other through a third component.

It will also be understood that when one component is referred to as being “on” or “over” another component, it can be directly on the other component or intervening components may also be present.

The terms “front”, “rear”, “left”, “right”, “upper”, and “lower” used in the following description are defined based on the drawings, and the shape and location of each component are not limited by these terms. For example, the front side may be defined as the +X side and the rear side may be defined as the −X side. For example, based on the drawings, the right side may be defined as the +Y side and the left side may be defined as the −Y side. For example, based on the drawings, the upper side may be defined as the +Z side and the lower side may be defined as the −Z side.

A water treatment apparatus according to various embodiments may purify contaminated water to a clean state. The water treatment apparatus is used in wastewater treatment facilities, industrial processes, and water supply systems used in homes and offices, playing an important role in environmental protection and human health. Clean water purified by the water treatment apparatus may be returned to nature or used for cleaning purposes, used as drinking water, or reused in industrial processes or the like.

According to various embodiments, the water treatment apparatus may include not only household water treatment apparatuses such as a water purifier or a water softener but also industrial water treatment apparatuses.

The water treatment apparatus may purify raw water, introduced from outside, using a variety of methods, including biological, chemical, and physical treatment methods.

The water treatment apparatus according to one or more embodiments may produce purified water by purifying raw water introduced from outside using an electrochemical method among chemical treatment methods. For example, the water treatment apparatus may produce purified water by purifying raw water introduced from outside using at least one method of electrodialysis (ED), electrodeionization (EDI), or capacitive deionization (CDI).

Hereinafter, for convenience of description, a water treatment apparatus according to one or more embodiments is described as an apparatus that produces purified water from raw water introduced from outside using a CDI method.

The CDI method refers to a method of removing ions from raw water using a principle that ions are adsorbed to and desorbed from the surfaces of electrodes by an electrical force generated between the electrodes. Throughout the specification, removing ions from raw water may include removing ionic substances of raw water.

Hereinafter, various embodiments of the disclosure are described in detail with reference to the accompanying drawings.

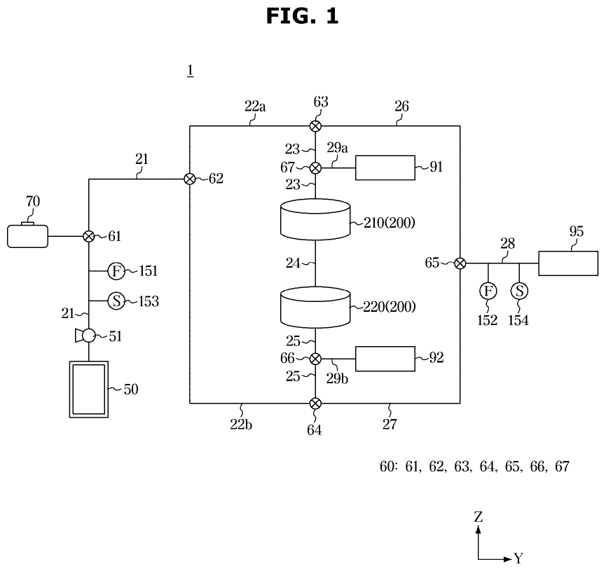

FIG. 1 is a conceptual diagram illustrating an example of a water treatment apparatus according to one or more embodiments.

Referring to FIG. 1, a water treatment apparatus 1 according to one or more embodiments may treat water supplied from a water source 50 where water is stored or water is supplied from an external source. The water stored or supplied by the water source 50 may be referred to as raw water.

The water treatment apparatus 1 may include a pump 51 for pumping external water (e.g., water supplied from the water source 50).

The water treatment apparatus 1 may include a first water supply guide 21 configured to allow water pumped by the pump 51 to flow.

Water pumped by the pump 51 may flow through the first water supply guide 21.

A pre-filter may be provided in the first water supply guide 21. The pre-filter may be supplied with the water pumped by the pump 51 to remove substances, such as relatively large suspended particulate matter, dust, and sand contained in the water, or to remove organic chemicals, carcinogens, residual chlorine, etc. contained in the water.

The water treatment apparatus 1 may include a storage compartment 70 connected to the first water supply guide 21 and storing a descaling agent.

The storage compartment 70 may store a descaling agent for removing scale from a first electrode module 210 and a second electrode module 220.

In a case where a deionization operation of removing ionic substances from water through electrochemical adsorption on electrodes and a regeneration operation of desorbing the adsorbed ionic substances are repeated, scale may be accumulated (deposited) on the electrodes, and an efficiency of a water treatment process may be reduced.

Accordingly, a descaling operation is required to remove scale accumulated on the electrode. The descaling agent may include an acidic substance (e.g., citric acid) for removing the scale accumulated on the electrode.

The water treatment apparatus 1 may include a second water supply guide 22a and/or a third water supply guide 22b to allow water flowing from the first water supply guide 21 to flow.

Water flowing from the first water supply guide 21 may flow through the second water supply guide 22a or through the third water supply guide 22b.

The water treatment apparatus 1 may include a first inlet/outlet guide 23 to allow water introduced from the second water supply guide 22a to flow or allow water discharged from the first electrode module 210 to flow.

The water treatment apparatus 1 may include a second inlet/outlet guide 25 to allow water introduced from the third water supply guide 22b to flow or allow water discharged from the second electrode module 220 to flow.

The water treatment apparatus 1 may include a plurality of electrode modules 200. The plurality of electrode modules 200 may include the first electrode module 210 and the second electrode module 220.

Although two electrode modules are shown in FIG. 1, the water treatment apparatus 1 may include more than two electrode modules according to various embodiments. Hereinafter, it is assumed that two electrode modules are provided.

Each of the first electrode module 210 and the second electrode module 220 may remove ionic substances from external water (e.g., water supplied from a water source) using an electrochemical method (e.g., electrodialysis (ED), electrodeionization (EDI), and capacitive deionization (CDI)). The ionic substances may include sodium ions Na+, potassium ions K+, magnesium ions Mg2+, calcium ions Ca2+, and the like.

Hereinafter, an arrangement of the plurality of electrode modules 200, including the first electrode module 210 and the second electrode module 220, is described.

A first side of each of the first electrode module 210 and the second electrode module 220 may include a lower side of each of the first electrode module 210 and the second electrode module 220. The lower side of each of the first electrode module 210 and the second electrode module 220 may include a side corresponding to a lower direction (−Z direction) of each of the first electrode module 210 and the second electrode module 220.

A second side of each of the first electrode module 210 and the second electrode module 220 may include an upper side of each of the first electrode module 210 and the second electrode module 220. The upper side of each of the first electrode module 210 and the second electrode module 220 may include a side corresponding to an upper direction (+Z direction) of each of the first electrode module 210 and the second electrode module 220.

However, each of the first side and the second side is not limited thereto, and the first side and the second side may be defined according to various embodiments. For example, the first side may be an upper side and the second side may be a lower side. In addition, the first side may be a left side and the second side may be a right side.

Hereinafter, for convenience of description, the first side is described as a lower side and the second side is described as an upper side.

The second electrode module 220 may be disposed adjacent to the lower side of the first electrode module 210.

The first electrode module 210 may be disposed adjacent to the upper side of the second electrode module 220.

The first electrode module 210 may be connected to the first inlet/outlet guide 23. For example, the upper side of the first electrode module 210 may be connected to the first inlet/outlet guide 23.

Water may be introduced from the first inlet/outlet guide 23 into the first electrode module 210. In addition, water discharged from the first electrode module 210 may flow to the first inlet/outlet guide 23.

The second electrode module 220 may be connected to the second inlet/outlet guide 25. For example, the lower side of the second electrode module 220 may be connected to the second inlet/outlet guide 25.

Water may be introduced from the second inlet/outlet guide 25 into the second electrode module 220. In addition, water discharged from the second electrode module 220 may flow to the second inlet/outlet guide 25.

An intermediate guide 24 may be arranged between the first electrode module 210 and the second electrode module 220. The intermediate guide 24 may connect between the first electrode module 210 and the second electrode module 220 to allow water discharged from the first electrode module 210 to be introduced into the second electrode module 220, or allow water discharged from the second electrode module 220 to be introduced into the first electrode module 210.

The water treatment apparatus 1 may include a first drain device 91 and a second drain device 92 to drain water discharged from the first electrode module 210 and the second electrode module 220 to the outside.

The first drain device 91 may be connected to the first inlet/outlet guide 23 to allow water flowing from the first inlet/outlet guide 23 to be drained. For example, water flowing from the first inlet/outlet guide 23 may flow to the first drain device 91 through a first drain guide 29a.

The second drain device 92 may be connected to the second inlet/outlet guide 25 to allow water flowing from the second inlet/outlet guide 25 to be drained. For example, water flowing from the second inlet/outlet guide 25 may flow to the second drain device 92 through a second drain guide 29b.

The water treatment apparatus 1 may include a first water outlet guide 26, a second water outlet guide 27, and/or a third water outlet guide 28 to allow water that has passed through the first electrode module 210 and the second electrode module 220 to flow.

Water flowing from the third water supply guide 22b and passing through the second electrode module 220 and the first electrode module 210 may flow through the first water outlet guide 26.

Water flowing from the second water supply guide 22a and passing through the first electrode module 210 and the second electrode module 220 may flow through the second water outlet guide 27.

Water flowing from the first water outlet guide 26 or water flowing from the second water outlet guide 27 may flow through the third water outlet guide 28.

Although not shown in FIG. 1, a post-filter (not shown) may be provided in the third water outlet guide 28. The post-filter (not shown) may remove unpleasant taste, odor, scent, etc. of water flowing through the third water outlet guide 28.

Water flowing from the third water outlet guide 28 may be discharged through a water outlet member 95.

The water discharged through the water outlet member 95 may include purified water obtained by purifying external water. The water discharged through the water outlet member may be used for various purposes, such as drinking, cooking, and washing.

The water treatment apparatus 1 may include a plurality of flow sensors 151 and 152 and/or a plurality of concentration sensors 153 and 154.

The plurality of flow sensors 151 and 152 may include the first flow sensor 151 and the second flow sensor 152.

The first flow sensor 151 may be arranged on the first water supply guide 21. The second flow sensor 152 may be arranged on the third water outlet guide 28.

The plurality of concentration sensors 153 and 154 may include the first concentration sensor 153 and the second concentration sensor 154.

The first concentration sensor 153 may be arranged on the first water supply guide 21. The second concentration sensor 154 may be arranged on the third water outlet guide 28.

However, the plurality of flow sensors 151 and 152 and the plurality of concentration sensors 153 and 154 may be arranged at various positions of the water treatment apparatus 1 according to various embodiments. For example, the second flow sensor 152 and the second concentration sensor 154 may be arranged on the first water outlet guide 26 or the second water outlet guide 27.

The water treatment apparatus 1 may include at least one valve 60.

The at least one valve 60 may include a descale valve 61 configured to allow water to flow through the first water supply guide 21 via the storage compartment 70 or by bypassing the storage compartment 70.

The at least one valve 60 may include a water supply valve 62 configured to allow water to flow from the first water supply guide 21 to the second water supply guide 22a or to the third water supply guide 22b.

The water supply valve 62 may allow or block water from flowing from the first water supply guide 21 to the second water supply guide 22a.

The water supply valve 62 may allow or block water from flowing from the first water supply guide 21 to the third water supply guide 22b.

The at least one valve 60 may include a first inlet/outlet valve 63 configured to allow water to flow from the second water supply guide 22a to the first inlet/outlet guide 23 or allow water to flow from the first inlet/outlet guide 23 to the first water outlet guide 26.

The first inlet/outlet valve 63 may allow water to flow from the second water supply guide 22a to the first inlet/outlet guide 23, and simultaneously block water from flowing from the second water supply guide 22a to the first water outlet guide 26.

The first inlet/outlet valve 63 may allow water to flow from the first inlet/outlet guide 23 to the first water outlet guide 26, and simultaneously block water from flowing from the second water supply guide 22a to the first water outlet guide 26 and the first inlet/outlet guide 23.

The at least one valve 60 may include a second inlet/outlet valve 64 configured to allow water to flow from the third water supply guide 22b to the second inlet/outlet guide 25 or allow water to flow from the second inlet/outlet guide 25 to the second water outlet guide 27.

The second inlet/outlet valve 64 may allow water to flow from the third water supply guide 22b to the second inlet/outlet guide 25, and simultaneously block water from flowing from the third water supply guide 22b to the second water outlet guide 27.

The second inlet/outlet valve 64 may allow water to flow from the second inlet/outlet guide 25 to the second water outlet guide 27, and simultaneously block water from flowing from the third water supply guide 22b to the second water outlet guide 27 and the second inlet/outlet guide 25.

The at least one valve 60 may include a water outlet valve 65 configured to allow water to flow from the first water outlet guide 26 to the third water outlet guide 28 or allow water to flow from the second water outlet guide 27 to the third water outlet guide 28.

The water outlet valve 65 may allow water to flow from the first water outlet guide 26 to the third water outlet guide 28, and simultaneously block water from flowing to the second water outlet guide 27.

The water outlet valve 65 may allow water to flow from the second water outlet guide 27 to the third water outlet guide 28, and simultaneously block water from flowing to the first water outlet guide 26.

The at least one valve 60 of the disclosure may include only the water supply valve 62 and the water outlet valve 65 among the water supply valve 62, the first inlet/outlet valve 63, the second inlet/outlet valve 64, and the water outlet valve 65. In addition, the at least one valve 60 of the disclosure may include only the first inlet/outlet valve 63 and the second inlet/outlet valve 64 among the water supply valve 62, the first inlet/outlet valve 63, the second inlet/outlet valve 64, and the water outlet valve 65.

However, for convenience of description, the at least one valve 60 is described as including all of the water supply valve 62, the first inlet/outlet valve 63, the second inlet/outlet valve 64, and the water outlet valve 65.

The at least one valve 60 may include a first drain valve 67 and/or a second drain valve 66 configured to allow water discharged from the first electrode module 210 and the second electrode module 220 to be drained to the outside.

The first drain valve 67 may allow or block water from flowing from the first inlet/outlet guide 23 to the first drain guide 29a.

The second drain valve 68 may allow or block water from flowing from the second inlet/outlet guide 23 to the second drain guide 29b.

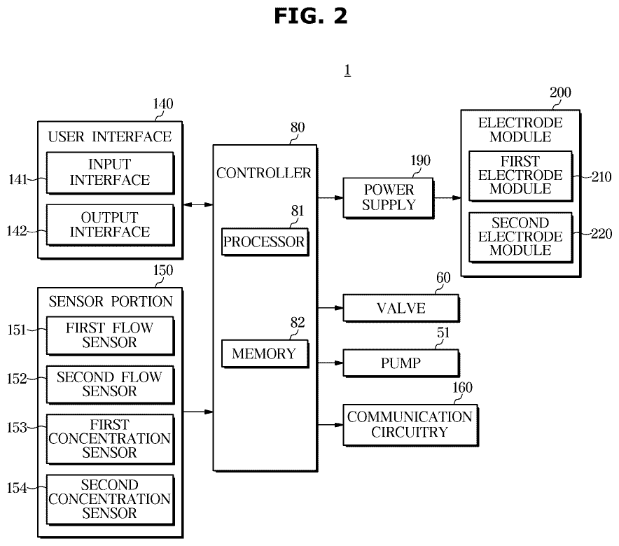

FIG. 2 is a control block diagram of a water treatment apparatus according to one or more embodiments.

Referring to FIG. 2, the water treatment apparatus 1 according to one or more embodiments may include a user interface 140, a sensor portion 150, a power supply 190, the plurality of electrode modules 200, the at least one valve 60, the pump 51, communication circuitry 160, and/or a controller 80.

The user interface 140 may include an input interface 141 and an output interface 142.

The input interface 141 may convert sensory information received from a user into an electrical signal.

The input interface 141 may include a power input interface for turning on the water treatment apparatus 1, an operation input interface for starting an operation of the water treatment apparatus 1, and a setting input interface. The input interface 141 may include, for example, a tact switch, a push switch, a slide switch, a toggle switch, a micro switch, a touch switch, a touch pad, a touch screen, a jog dial, and/or a microphone.

The output interface 142 may generate sensory information to transmit various information related to the operation of the water treatment apparatus 1 to a user.

For example, the output interface 142 may provide an operation time of the water treatment apparatus 1, information related to settings of the water treatment apparatus 1, and information obtained from the sensor portion 150 to a user. The information about the water treatment apparatus 1 may be output as a screen, an indicator, a voice, or the like. The output interface 142 may include, for example, a liquid crystal display (LCD) panel, a light emitting diode (LED) panel, a speaker, or the like.

The sensor portion 150 may include the plurality of flow sensors 151 and 152 and/or the plurality of concentration sensors 153 and 154.

The plurality of flow sensors 151 and 152 may include the first flow sensor 151 and the second flow sensor 152.

The first flow sensor 151 may measure a flow rate of water flowing through the first water supply guide 21. The second flow sensor 152 may measure a flow rate of water flowing through the third water outlet guide 28.

The plurality of concentration sensors 153 and 154 may include the first concentration sensor 153 and the second concentration sensor 154.

The first concentration sensor 153 may measure a concentration of water flowing through the first water supply guide 21. The second concentration sensor 154 may measure a concentration of water flowing through the third water outlet guide 28.

The first concentration sensor 153 and the second concentration sensor 154 may include a total dissolved solid (TDS) sensor that may measure a TDS contained in water. The TDS may include a total amount of ionic substances and organic substances dissolved in water.

The plurality of flow sensors 151 and 152 may transmit information about the measured flow rate of water to the controller 80.

The plurality of concentration sensors 153 and 154 may transmit information about the measured concentration of water to the controller 80.

The power supply 190 may supply power to the plurality of electrode modules 200, including the first electrode module 210 and the second electrode module 220. The power may include a voltage and/or a current applied to the plurality of electrode modules 200.

The power supply 190 may supply power having different magnitudes to each of the first electrode module 210 and the second electrode module 220.

The magnitude of the power may correspond to a magnitude of a voltage and/or a current supplied to each of the plurality of electrode modules 200, including the first electrode module 210 and the second electrode module 220. The magnitude of the voltage may include a value corresponding to an absolute value of the voltage. The magnitude of the current may include a value corresponding to an absolute value of the current.

The power supply 190 may supply different duty ratios of power to each of the first electrode module 210 and the second electrode module 220.

The duty ratio of the power may be a ratio of time during which power is supplied to the electrode module 200 over a predetermined period of time.

For example, in a case where the predetermined period of time is 1 minute, the power supply 190 may supply a voltage to the first electrode module 210 for 1 minute, and supply a voltage to the second electrode module 220 for 30 seconds.

The controller 80 may control the power supply 190 to supply power to the first electrode module 210 and/or the second electrode module 220.

The at least one valve 60 may change a direction of water according to a control signal from the controller 80. In addition, the controller 80 may adjust an opening degree of the at least one valve 60 according to a control signal.

The pump 51 may pump external water (e.g., water supplied from the water source 50) according to a control signal from the controller 80. As a result, external water may flow in the first water supply guide 21.

The communication circuitry 160 may communicate with an external device (e.g., a server, a user device, and/or a home appliance) by wire and/or wirelessly.

The communication circuitry 160 may include at least one of a short-range wireless communication module or a long-range wireless communication module.

The communication circuitry 160 may transmit data to an external device or receive data from an external device. For example, the communication circuitry 160 may establish communication with a server, a user device, and/or a home appliance, and may transmit and receive various data.

To this end, the communication circuitry 160 may support establishing a direct (e.g., wired) communication channel or a wireless communication channel between external devices, and performing communication over the established communication channel. According to one or more embodiments, the communication circuitry 160 may include a wireless communication module (e.g., a cellular communication module, a short-range wireless communication module, or a global navigation satellite system (GNSS) communication module) or a wired communication module (e.g., a local area network (LAN) communication module, or a power line communication module). A corresponding communication module of these communication modules may communicate with an external device via a first network (e.g., a short-range communication network such as Bluetooth, wireless fidelity (Wi-Fi) direct, or infrared data association (IrDA)) or a second network (e.g., a long-range communication network such as a legacy cellular network, 5G network, next generation communication network, the Internet, or a computer network (e.g., LAN or WAN)). These different types of communication modules may be integrated into a single component (e.g., a single chip) or may be implemented as separate components (e.g., a plurality of chips).

The short-range wireless communication module may include a Bluetooth communication module, a Bluetooth low energy (BLE) communication module, a near field communication (NFC) communication module, a WLAN (Wi-Fi) communication module, a Zigbee communication module, an infrared data association (IrDA) communication module, a Wi-Fi direct (WFD) communication module, an ultra-wideband (UWB) communication module, an Ant+ communication module, a microwave (uWave) communication module, and the like, without being limited thereto.

The long-range wireless communication module may include a communication module performing various long-range wireless communications, and may include mobile communication circuitry. The mobile communication circuitry may transmit and receive radio signals with at least one of a base station, an external terminal, or a server over a mobile communication network.

In one or more embodiments, the communication circuitry 160 may communicate with an external device, such as a server, a user device, and a home appliance through a nearby access point (AP). The access point (AP) may connect a local area network (LAN) to which the water treatment apparatus 1, a home appliance, and/or a user device are connected to a wide area network (WAN) to which the server is connected. The water treatment apparatus 1, the home appliance, and/or the user device may be connected to the server via the wide area network (WAN).

The communication circuitry 160 may receive information about a flow rate of water and/or information about a concentration of water from an external device.

For example, in a case where sensors for measuring a flow rate of water and a concentration of water are installed outside the water treatment apparatus 1, the communication circuitry 160 may receive information about the flow rate and the concentration of water from the sensors installed outside the water treatment apparatus 1.

The information obtained by the communication circuitry 160 may be transmitted to the controller 80.

The controller 80 may control various components (e.g., the user interface 140, the sensor portion 150, the power supply 190, the at least one valve 60, the pump 51, and/or the communication circuitry 160) of the water treatment apparatus 1. For example, the controller 80 may control the power supply 190 to supply power having a different magnitude or a different duty ratio to each of the first electrode module 210 and the second electrode module 220.

The controller 80 may include hardware such as a CPU, a Micom, or a memory, and software such as a control program. For example, the controller 80 may include at least one memory 82 that stores data in the form of algorithms, programs, and the like for controlling operations of components in the water treatment apparatus 1, and/or at least one processor 81 that performs the above-described operations and operations to be described below using the data stored in the at least one memory 82. The memory 82 and the processor 81 may be implemented as separate chips. The processor 81 may include one or two or more processor chips, or may include one or two or more processing cores. The memory 82 may include one or two or more memory chips, or may include one or two or more memory blocks. In addition, the memory 82 and the processor 81 may also be implemented as a single chip.

The controller 80 may be electrically connected to the user interface 140, the sensor portion 150, the power supply 190, the at least one valve 60, the pump 51, and/or the communication circuitry 160.

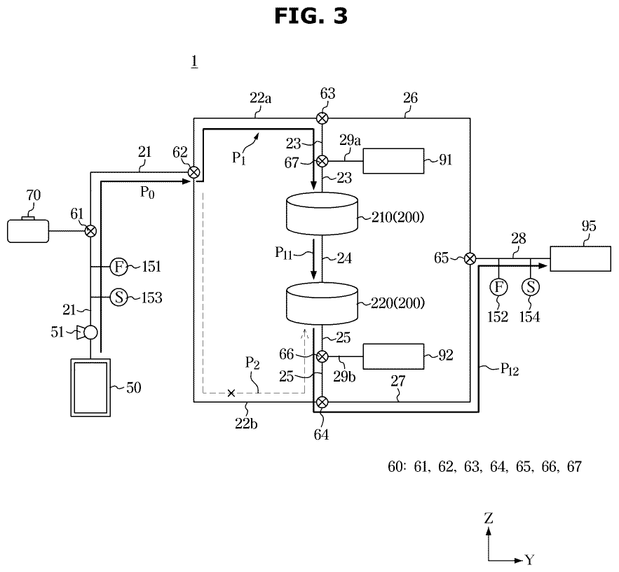

FIG. 3 illustrates an example of a direction of water supplied from a water supply flow path of a water treatment apparatus according to one or more embodiments.

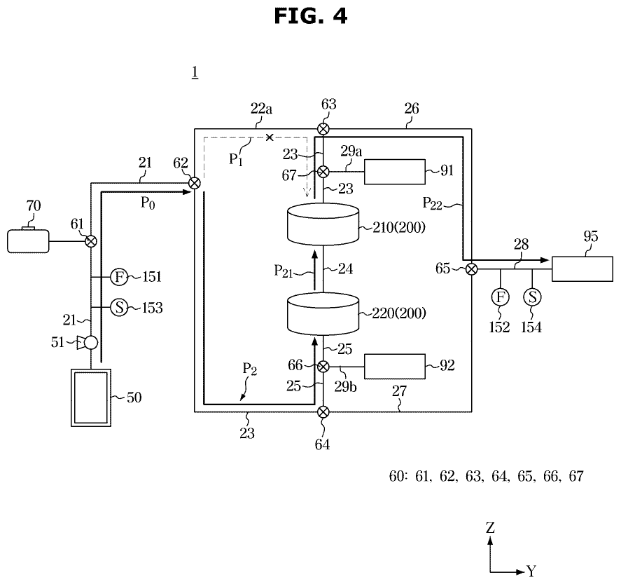

FIG. 4 illustrates an example different from FIG. 3 of a direction of water supplied from a water supply flow path of a water treatment apparatus according to one or more embodiments.

Referring to FIG. 3 and FIG. 4, the water treatment apparatus 1 according to one or more embodiments may include a water supply flow path P₀. The water supply flow path P₀ may include a flow path through which water flows through the first water supply guide 21.

Referring to FIG. 3, in one or more embodiments, the water treatment apparatus 1 may include a first guide flow path P₁ configured to guide water, supplied through the water supply flow path P₀, to an upper side of the first electrode module 210. The first guide flow path P₁ may include a flow path of water flowing through the second water supply guide 22a and the first inlet/outlet guide 23.

In one or more embodiments, the water treatment apparatus 1 may include an intermediate flow path connecting between the first electrode module 210 and the second electrode module 220. The intermediate flow path may include a first intermediate flow path P₁₁ through which water discharged after passing through the first electrode module 210 flows. Water flowing through the first intermediate flow path P₁₁ may be introduced into the second electrode module 220. The first intermediate flow path P₁₁ may include a flow path of water flowing through the intermediate guide 24.

The water treatment apparatus 1 may include a first water outlet flow path P₁₂ through which water discharged after passing through the second electrode module 220 flows.

The first water outlet flow path P₁₂ may include a flow path of water flowing through the second inlet/outlet guide 25, the second water outlet guide 27, and the third water outlet guide 28.

Referring to FIG. 4, in one or more embodiments, the water treatment apparatus 1 may include a second guide flow path P₂ configured to guide water flowing through the water supply flow path P₀ to a lower side of the second electrode module 220. The second guide flow path P₂ may include a flow path of water flowing through the third water supply guide 22b and the second inlet/outlet guide 25.

In one or more embodiments, the intermediate flow path may include a second intermediate flow path P₂₁ through which water discharged after passing through the second electrode module 220 flows. Water flowing through the second intermediate flow path P₂₁ may be introduced into the first electrode module 210. The second intermediate flow path P₂₁ may include a flow path of water flowing through the intermediate guide 24.

The water treatment apparatus 1 may include a second water outlet flow path P₂₂ through which water discharged after passing through the first electrode module 210 flows. The second water outlet flow path P₂₂ may include a flow path of water flowing through the first inlet/outlet guide 23, the first water outlet guide 26, and the third water outlet guide 28.

In various embodiments, the at least one valve 60 may switch a direction of water supplied through the water supply flow path P₀. Hereinafter, switching the direction of water supplied through the water supply flow path P₀ is described.

In one or more embodiments, the at least one valve 60 may switch the direction of water, supplied through the water supply flow path P₀, to the upper side of the first electrode module 210.

Referring to FIG. 3, in a state where the direction of water supplied through the water supply flow path P₀ is toward the lower side of the second electrode module 220, the at least one valve 60 may switch the direction of water, supplied through the water supply flow path P₀, to the upper side of the first electrode module 210 by connecting the water supply flow path P₀ and the first guide flow path P₁ and blocking the second guide flow path P₂.

Connecting the water supply flow path P₀ and the first guide flow path P₁ may include allowing, by the water supply valve 62, water to flow from the water supply flow path P₀ to the second water supply guide 22a.

Connecting the water supply flow path P₀ and the first guide flow path P₁ may include allowing, by the first inlet/outlet valve 63, water to be introduced into the first inlet/outlet guide 23 from the second water supply guide 22a.

When the water supply flow path P₀ and the first guide flow path P₁ are connected, the first inlet/outlet valve 63 may block water from flowing from the second water supply guide 22a to the first water outlet guide 26.

Blocking the second guide flow path P₂ may include blocking, by the water supply valve 62, water from flowing from the water supply flow path P₀ to the third water supply guide 22b.

Blocking the second guide flow path P₂ may include blocking water from being introduced into the second inlet/outlet guide 25 from the third water supply guide 22b. That is, even in a case where water supplied through the water supply flow path P₀ flows through the third water supply guide 22b, water flowing through the third water supply guide 22b may be blocked from being introduced into the second inlet/outlet guide 25, thereby blocking the second guide flow path P₂.

In one or more embodiments, the at least one valve 60 may switch the direction of water, supplied through the water supply flow path P₀, to the lower side of the second electrode module 220.

Referring to FIG. 4, in a state where the direction of water supplied through the water supply flow path P₀ is toward the upper side of the first electrode module 210, the at least one valve 60 may switch the direction of water, supplied through the water supply flow path P₀, to the lower side of the second electrode module 220 by connecting the water supply flow path P₀ and the second guide flow path P₂ and blocking the first guide flow path P₁.

Connecting the water supply flow path P₀ and the second guide flow path P₂ may include allowing, by the water supply valve 62, water to flow from the water supply flow path P0 to the third water supply guide 22b.

Connecting the water supply flow path P₀ and the second guide flow path P₂ may include allowing, by the second inlet/outlet valve 64, water to be introduced into the second inlet/outlet guide 25 from the third water supply guide 22b.

When the water supply flow path P₀ and the second guide flow path P₂ are connected, the second inlet/outlet valve 64 may block water from flowing from the third water supply guide 22b to the second water outlet guide 27.

Blocking the first guide flow path P₁ may include blocking, by the water supply valve 62, water from flowing from the water supply flow path P₀ to the second water supply guide 22a.

Blocking the first guide flow path P₁ may include blocking water from being introduced into the first inlet/outlet guide 23 from the second water supply guide 22a. That is, even in a case where water supplied through the water supply flow path P₀ flows through the second water supply guide 22a, water flowing through the second water supply guide 22a may be blocked from being introduced into the first inlet/outlet guide 23, thereby blocking the first guide flow path P₁.

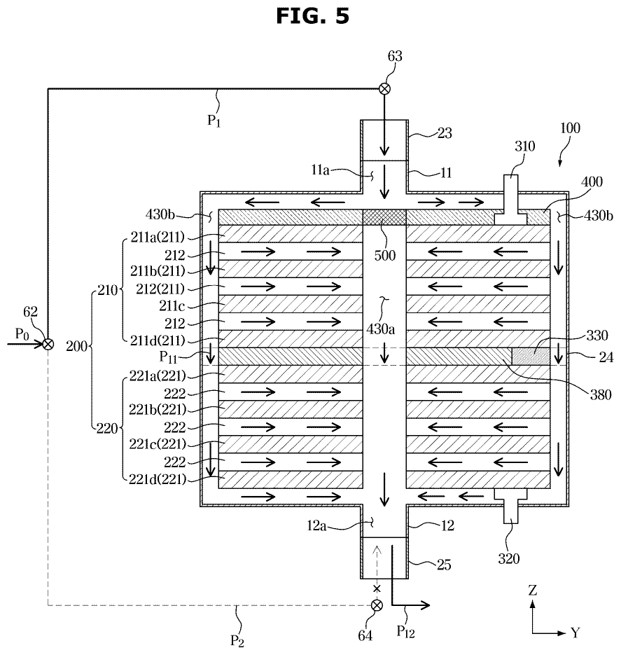

FIG. 5 illustrates an example of water supplied from a water supply flow path of a water treatment apparatus passing through an electrode module according to one or more embodiments.

Referring to FIG. 5, the water treatment apparatus 1 according to one or more embodiments may include a housing 100.

The housing 100 may accommodate the plurality of electrode modules 200. For example, the housing 100 may accommodate the first electrode module 210 and the second electrode module 220.

The first electrode module 210 may include a plurality of first electrodes 211, including electrode 211a, electrode 211b, electrode 211c, and electrode 211d. The first electrode module 210 may include a plurality of first ion exchange layers 212 disposed between each of the plurality of first electrodes 211a, including electrode 211a, electrode 211b, electrode 211c, and electrode 211d.

Each of the plurality of first electrodes 211a, including electrode 211a, electrode 211b, electrode 211c, and electrode 211d and each of the plurality of first ion exchange layers 212 may be provided in a cylindrical shape in which a hollow is formed at a position corresponding to a central part of the housing 100.

The second electrode module 220 may include a plurality of second electrodes 221, including electrode 221a, electrode 221b, electrode 221c, and electrode 221d. The second electrode module 220 may include a plurality of second ion exchange layers 222 disposed between each of the plurality of second electrodes 221, including electrode 221a, electrode 221b, electrode 221c, and electrode 221d.

Each of the plurality of second electrodes 221, including electrode 221a, electrode 221b, electrode 221c, and electrode 221d, and each of the plurality of second ion exchange layers 222 may be provided in a cylindrical shape in which a hollow is formed at a position corresponding to the central part of the housing 100.

A first flow hole 430a may be formed in the hollow at the central part of the housing 100.

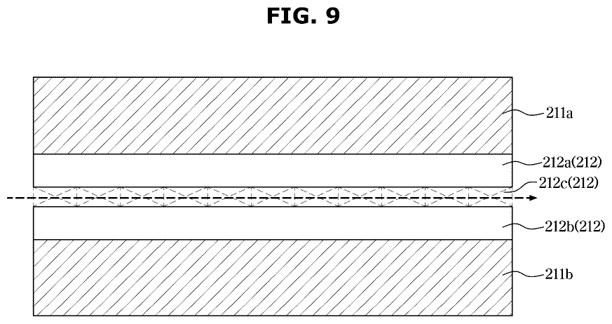

The first ion exchange layer 212 may include a spacer 212c (see FIG. 9) to allow water flowing inside the housing 100 to flow between the plurality of first electrodes 211a, 211b, 211c, 211d, and an anion exchange membrane 212a (see FIG. 9) and a cation exchange membrane 212b (see FIG. 9) to exchange ionic substances contained in the water.

The second ion exchange layer 222 may have the same structure as the first ion exchange layer 212. For example, the second ion exchange layer 222 may also include a spacer to allow water flowing inside the housing 100 to flow between the plurality of second electrodes 221, including electrode 221a, electrode 221b, electrode 221c, and electrode 221d,, and an anion exchange membrane and a cation exchange membrane to exchange ionic substances contained in the water.

A second flow hole 430b may be formed between a side surface of the housing 100 and the plurality of electrode modules 200, including the first electrode module 210 and the second electrode module 220, to allow water introduced into the housing 100 to flow.

A distribution plate 400 may be disposed on the upper side of the first electrode module 210 so as to allow water introduced through a first opening 11a to flow to the second flow hole 430b. A distribution portion 500 may be positioned at the center of the distribution plate 400 to allow water introduced through the first opening 11a to flow along one surface of the distribution plate 400. Accordingly, by the distribution portion 500, water introduced through the first opening 11a may flow through the second flow hole 430b along one surface of the distribution plate 400.

The distribution plate 400 may be provided with a first electrode terminal 310 to supply power to the first electrode module 210. The first electrode terminal 310 may be connected to the power supply 190 to allow power to be supplied to the first electrode module 210.

A second electrode terminal 320 may be provided on the lower side of the second electrode module 220 to supply power to the second electrode module 220. The second electrode terminal 320 may be connected to the power supply 190 to allow power to be supplied to the second electrode module 220.

A separation plate 380 may be provided between the first electrode module 210 and the second electrode module 220.

On one side of the separation plate 380, a third electrode terminal 330 may be disposed between the first electrode module 210 and the second electrode module 220 to supply power to the first electrode module 210 and the second electrode module 220.

A portion of the third electrode terminal 330 may be disposed inside the housing 100.

Although FIG. 5 illustrates the third electrode terminal 330 as being fully disposed inside the housing 100, a portion of the third electrode terminal 330 may be disposed inside the housing 100, with the remaining portion disposed outside the housing 100.

The third electrode terminal 330 may be connected to the power supply 190 to allow power to be supplied to the first electrode module 210 and the second electrode module 220.

The first electrode module 210 and the second electrode module 220 may be bipolar electrode modules. Unlike the monopolar (or unipolar) method which supplies power to all the electrodes included in an electrode module, the bipolar method supplies power only to a pair of electrodes disposed at the outermost positions among a plurality of electrodes included in the electrode module. Accordingly, in the bipolar method, one side of each electrode included in the electrode module functions as a positive electrode, and the other side functions as a negative electrode.

For example, when the power supply 190 supplies power to the first electrode 211a disposed on an upper side among the plurality of first electrodes 211, including electrode 211a, electrode 211b, electrode 211c, and electrode 211d, through the first electrode terminal 310, and supplies power to the first electrode 211d disposed on a lower side among the plurality of first electrodes 211, including electrode 211a, electrode 211b, electrode 211c, and electrode 211d, through the third electrode terminal 330, one side of each of the plurality of first electrodes 211, including electrode 211a, electrode 211b, electrode 211c, and electrode 211d, may function as a positive electrode and the other side may function as a negative electrode.

As another example, when the power supply 190 supplies power to the second electrode 221d disposed on a lower side among the plurality of second electrodes 221, including electrode 221a, electrode 221b, electrode 221c, and electrode 221d, through the second electrode terminal 320, and supplies power to the second electrode 221a disposed on an upper side among the plurality of second electrodes 221, including electrode 221a, electrode 221b, electrode 221c, and electrode 221d, through the third electrode terminal 330, one side of each of the plurality of second electrodes 221, including electrode 221a, electrode 221b, electrode 221c, and electrode 221d, may function as a positive electrode and the other side may function as a negative electrode.

According to the disclosure, different power may be supplied to each of the first electrode module 210 and the second electrode module 220 by the first electrode terminal 310, the second electrode terminal 320, and the third electrode terminal 330.

For example, in a case where the power supply 190 supplies negative power through the third electrode terminal 330 and positive power through the first electrode terminal 310 and the second electrode terminal 320, the power supply 190 may supply different magnitudes or different duty ratios of power to the first electrode module 210 and the second electrode module 220, by adjusting the magnitude or duty ratio of the positive power supplied through the first electrode terminal 310 and the second electrode terminal 320.

The housing 100 may include a first inlet/outlet portion 11 connected to the first inlet/outlet guide 23. The first inlet/outlet portion 11 may be provided on the upper side of the first electrode module 210.

In one or more embodiments, the housing 100 may include the first opening 11a provided on the upper side of the first electrode module 210. For example, the first opening 11a may be formed in the first inlet/outlet portion 11 on the upper side of the first electrode module 210.

In one or more embodiments, the first guide flow path P₁ may guide water, supplied through the water supply flow path P₀, to the first opening 11a.

For example, water supplied through the water supply flow path P₀ may flow to the first guide flow path P₁, thereby being introduced into the first opening 11a formed in the first inlet/outlet portion 11.

Water introduced into the first opening 11a may flow through the second flow hole 430b. Water flowing through the second flow hole 430b may pass through the first electrode module 210 and the second electrode module 220, and flow to the first flow hole 430a. For example, water flowing through the second flow hole 430b may pass through the first electrode module 210 and the second electrode module 220 through the first ion exchange layer 212 and the second ion exchange layer 222, and flow to the first flow hole 430a.

The housing 100 may include a second inlet/outlet portion 12 connected to the second inlet/outlet guide 25. The second inlet/outlet portion 12 may be provided on the lower side of the second electrode module 220.

In one or more embodiments, the housing 100 may include a second opening 12a provided on the lower side of the second electrode module 220. For example, the second opening 12a may be formed in the second inlet/outlet portion 12 on the lower side of the second electrode module 220.

Water flowing to the first flow hole 430a may flow to the second opening 12a through the first flow hole 430a.

Water flowing to the second opening 12a may be discharged to the second inlet/outlet guide 25. Water discharged to the second inlet/outlet guide 25 may flow through the first water outlet flow path P₁₂.

In a case where the housing 100 accommodates the first electrode module 210 and the second electrode module 220 as shown in FIG. 5, the intermediate guide 24 (see FIG. 1) may correspond to a guide formed by the separation plate 380 between the first electrode module 210 and the second electrode module 220. In addition, the first intermediate flow path P₁₁ may include a flow path through which water flows through the guide formed by the separation plate 380.

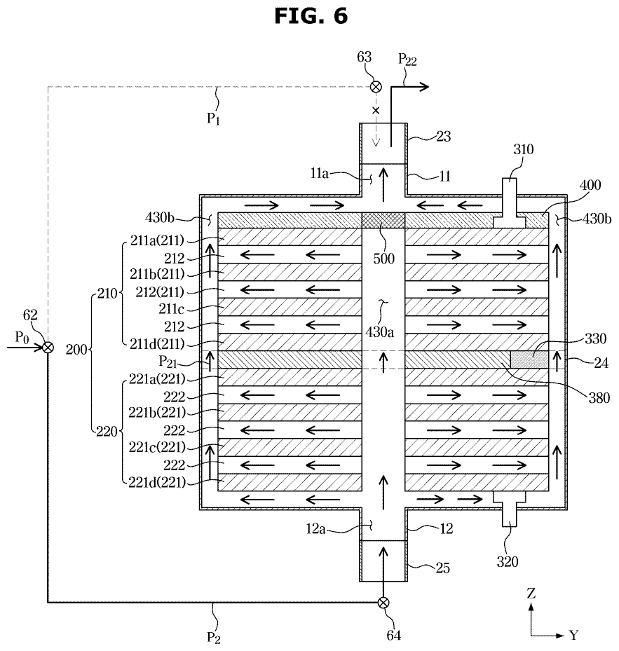

FIG. 6 illustrates an example, different from FIG. 5, in which water supplied from a water supply flow path of a water treatment apparatus passes through an electrode module according to one or more embodiments.

Referring to FIG. 6, the second guide flow path P₂ may guide water, supplied through the water supply flow path P₀, to the second opening 12a.

For example, water supplied through the water supply flow path P₀ may flow to the second guide flow path P₂, and be guided to the second opening 12a formed in the second inlet/outlet portion 12.

Water guided to the second opening 12a may flow through the first flow hole 430a and the second flow hole 430b. Water flowing through the first flow hole 430a may pass through the first electrode module 210 and the second electrode module 220, and flow to the second flow hole 430b. For example, water flowing through the first flow hole 430a may pass through the first electrode module 210 and the second electrode module 220 through the first ion exchange layer 212 and the second ion exchange layer 222, and flow to the second flow hole 430b.

Water flowing through the second flow hole 430b may flow along one surface of the distribution plate 400, and flow to the first opening 11a.

Water flowing to the first opening 11a may be discharged to the first inlet/outlet guide 23. Water discharged to the first inlet/outlet guide 23 may flow through the second water outlet flow path P₂₂.

In one or more embodiments, the at least one valve 60 may switch the direction of water, supplied through the water supply flow path P₀, to the upper side of the first electrode module 210 by connecting the water supply flow path P₀ and the first guide flow path P₁ and blocking the second guide flow path P₂.

For example, referring to FIG. 5, in a state where the direction of water supplied through the water supply flow path P₀ is toward the lower side of the second electrode module 220, the water supply valve 62 and the first inlet/outlet valve 63 may connect the water supply flow path P₀ and the first guide flow path P₁ by allowing water to flow from the water supply flow path P₀ to the first opening 11a. In addition, the water supply valve 62 and/or the second inlet/outlet valve 64 may block the second guide flow path P₂ by blocking water from flowing from the water supply flow path P₀ to the second opening 12a.

In one or more embodiments, the at least one valve 60 may switch the direction of water, supplied through the water supply flow path P₀, to the lower side of the second electrode module 220 by connecting the water supply flow path P₀ and the second guide flow path P₂ and blocking the first guide flow path P₁.

For example, referring to FIG. 6, in a state where the direction of water supplied through the water supply flow path P₀ is toward the lower side of the second electrode module 220, the water supply valve 62 and the second inlet/outlet valve 64 may connect the water supply flow path P₀ and the second guide flow path P₂ by allowing water to flow from the water supply flow path P₀ to the second opening 12a. In addition, the water supply valve 62 and/or the first inlet/outlet valve 63 may block the first guide flow path P₁ by blocking water from flowing from the water supply flow path P₀ to the first opening 11a.

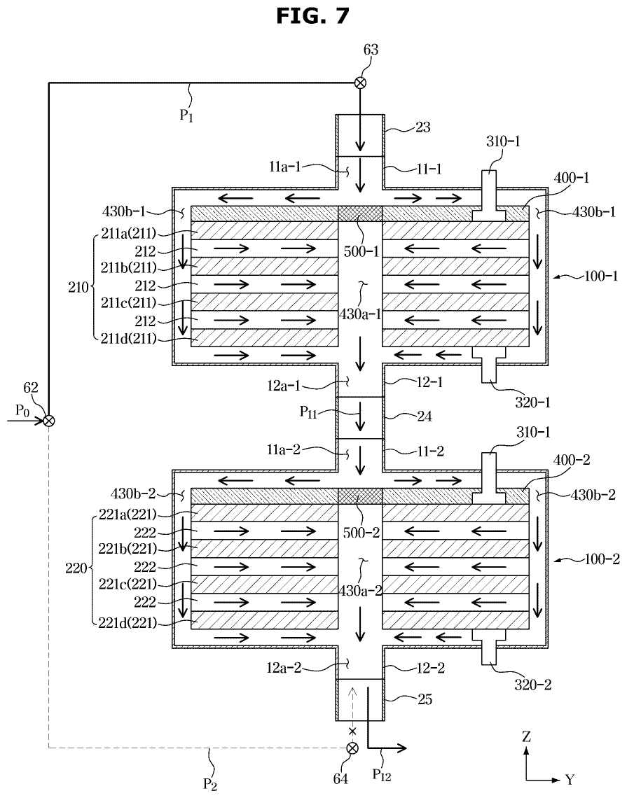

FIG. 7 illustrates an example of water supplied from a water supply flow path of a water treatment apparatus passing through an electrode module according to another embodiment different from FIG. 5.

Referring to FIG. 7, the water treatment apparatus 1 according to another embodiment may include a first housing 100-1 and a second housing 100-2.

The first housing 100-1 according to another embodiment may accommodate the first electrode module 210 among the plurality of electrode modules 200.

The first housing 100-1 may have the same configuration as the housing 100 shown in FIG. 5. For example, the first housing 100-1 may include a first inlet/outlet portion 11-1 and a second inlet/outlet portion 12-1.

The first housing 100-1 may include the same components as the housing 100 shown in FIG. 5. For example, the first housing 100-1 may include a distribution plate 400-1, a distribution portion 500-1, a first flow hole 430a-1, a second flow hole 430b-1, a first electrode terminal 310-1, and a second electrode terminal 320-1.

Among the components of the housing 100 shown in FIG. 5, the third electrode terminal 330 may not be included in the first housing 100-1. In this case, by applying power to the first electrode 211a disposed on an upper side among the plurality of first electrodes 211a, including electrode 211a, electrode 211b, electrode 211c, and electrode 211d, through the first electrode terminal 310-1, and applying power to the first electrode 211d disposed on a lower side among the plurality of first electrodes 211a, including electrode 211a, electrode 211b, electrode 211c, and electrode 211d, through the second electrode terminal 320-1, one side of each of the plurality of first electrodes 211a, including electrode 211a, electrode 211b, electrode 211c, and electrode 211d, may function as a positive electrode and the other side may function as a negative electrode.

The first housing 100-1 according to another embodiment may include a first housing opening 11a-1 provided on the upper side of the first electrode module 210.

The first housing opening 11a-1 may be formed in the first inlet/outlet portion 11-1 of the first housing 100-1 on the upper side of the first electrode module 210.

The first inlet/outlet portion 11-1 of the first housing 100-1 may be connected to the first inlet/outlet guide 23.

The first housing 100-1 according to another embodiment may include a first housing connection opening 12a-1 provided on the lower side of the first electrode module 210.

The first housing connection opening 12a-1 may be formed in the second inlet/outlet portion 12-1 of the first housing 100-1 on the lower side of the first electrode module 210.

The second housing 100-2 according to another embodiment may accommodate the second electrode module 220 among the plurality of electrode modules 200.

The second housing 100-2 may have the same configuration as the housing 100 shown in FIG. 5. For example, the second housing 100-2 may include a first inlet/outlet portion 11-2 and a second inlet/outlet portion 12-2.

The second housing 100-2 may include the same components as the housing 100 shown in FIG. 5. For example, the second housing 100-2 may include a distribution plate 400-2, a distribution portion 500-2, a first flow hole 430a-2, a second flow hole 430b-2, a first electrode terminal 310-2, a second electrode terminal 320-2, the first inlet/outlet portion 11-2, and the second inlet/outlet portion 12-2.

Among the components of the housing 100 shown in FIG. 5, the third electrode terminal 330 may not be included in the second housing 100-2. In this case, by applying power to the second electrode 221a disposed on an upper side among the plurality of second electrodes 221, including electrode 221a, electrode 221b, electrode 221c, and electrode 221d, through the first electrode terminal 310-2, and applying power to the second electrode 211d disposed on a lower side among the plurality of second electrodes 221, including electrode 221a, electrode 221b, electrode 221c, and electrode 221d, through the second electrode terminal 320-2, one side of each of the plurality of second electrodes 221, including electrode 221a, electrode 221b, electrode 221c, and electrode 221d, may function as a positive electrode and the other side may function as a negative electrode.

The second housing 100-2 according to another embodiment may include a second housing connection opening 11a-2 provided on an upper side of the second electrode module 220.

The second housing connection opening 11a-2 may be formed in the first inlet/outlet portion 11-2 of the second housing 100-2 on the upper side of the second electrode module 220.

The second housing 100-2 according to another embodiment may include a second housing opening 12a-2 provided on the lower side of the second electrode module 220.

The second housing opening 12a-2 may be formed in the second inlet/outlet portion 12-2 of the second housing 100-2 on the lower side of the second electrode module 220.

The second inlet/outlet portion 12-2 of the second housing 100-2 may be connected to the second inlet/outlet guide 25.

In one or more embodiments, the water treatment apparatus 1 may include an intermediate flow path connecting the first housing connection opening 12a-1 and the second housing connection opening 11a-2.

For example, the intermediate flow path may include a flow path formed by connecting the second inlet/outlet portion 12-1 of the first housing 100-1 and the first inlet/outlet portion 11-2 of the second housing 100-2 with the intermediate guide 24.

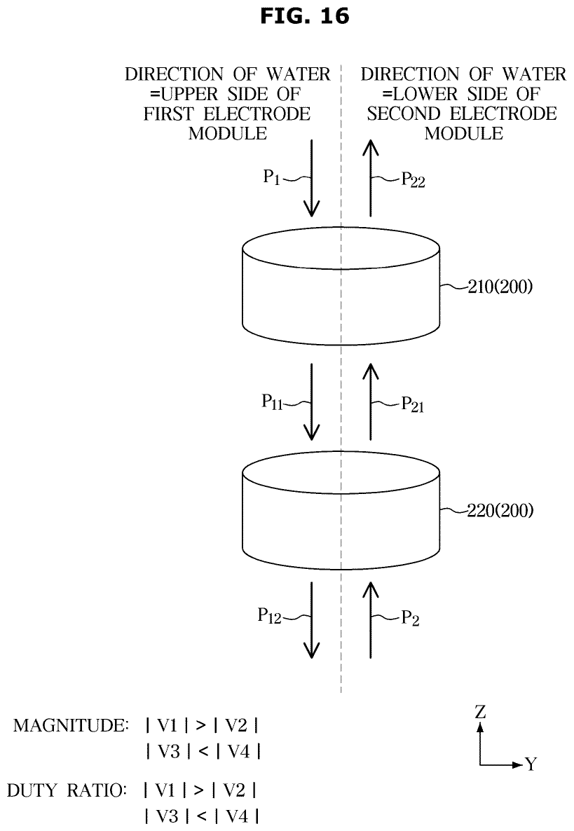

The intermediate flow path may include the first intermediate flow path P₁₁ that guides water discharged from the first housing 100-1 to the second housing 100-2, and the second intermediate flow path P₂₁ (FIG. 16) that guides water discharged from the second housing 100-2 to the first housing 100-1.

In one or more embodiments, the first guide flow path P₁ may guide water, supplied through the water supply flow path P₀, to the first housing opening 11a-1 of the first housing 100-1.

For example, water supplied through the water supply flow path P₀ may flow to the first guide flow path P₁, thereby being introduced into the first housing opening 11a-1 formed in the first inlet/outlet portion 11-1 of the first housing 100-1.

Water introduced into the first housing opening 11a-1 may flow through a second flow hole 430b-1 in the first housing 100-1. Water flowing through the second flow hole 430b-1 in the first housing 100-1 may pass through the first electrode module 210, and flow to the first flow hole 430a-1 in the first housing 100-1. For example, water flowing through the second flow hole 430b-1 in the first housing 100-1 may pass through the first electrode module 210 through the first ion exchange layer 212, and flow to the first flow hole 430a-1 in the first housing 100-1.

Water flowing to the first flow hole 430a-1 of the first housing 100-1 may flow to the first housing connection opening 11a-2 through the first flow hole 430a-1 in the first housing 100-1.

Water flowing to the first housing connection opening 12a-1 may be discharged to the intermediate guide 24. Water discharged to the intermediate guide 24 may be guided to the second housing 100-2 through the first intermediate flow path P₁₁ formed by the intermediate guide 24. For example, water flowing through the first intermediate flow path P₁₁ may be introduced into the second housing connection opening 11a-2 formed in the first inlet/outlet portion 11-2 of the second housing 100-2.

Water introduced into the second housing connection opening 11a-2 may flow through the second flow hole 430b-2 inside the second housing 100-2. Water flowing through the second flow hole 430b-2 in the second housing 100-2 may pass through the second electrode module 220, and flow to the first flow hole 430a-2 in the second housing 100-2. For example, water flowing through the second flow hole 430b-2 in the second housing 100-2 may pass through the second electrode module 220 through the second ion exchange layer 222, and flow to the first flow hole 430a-1 in the second housing 100-2.

Water flowing to the first flow hole 430a-2 of the second housing 100-2 may flow to the second housing opening 12a-2 through the first flow hole 430a-1 in the second housing 100-2.

Water flowing to the second housing opening 12a-2 may be discharged to the second inlet/outlet guide 25. Water discharged to the second inlet/outlet guide 25 may flow through the first water outlet flow path P₁₂.

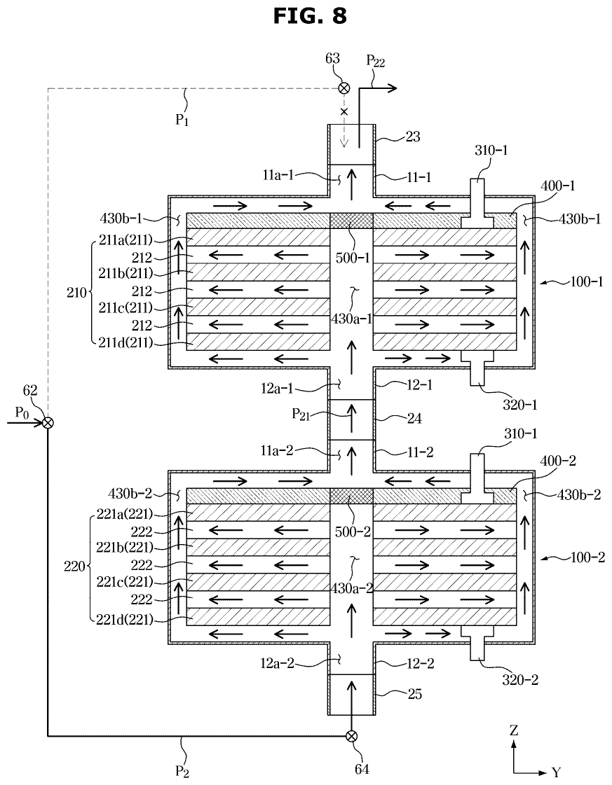

FIG. 8 illustrates an example, different from FIG. 7, in which water supplied from a water supply flow path passes through an electrode module of a water treatment apparatus according to another embodiment different from FIG. 5.

Referring to FIG. 8, the second guide flow path P₂ may guide water, supplied through the water supply flow path P₀, to the second housing opening 12a-2.

For example, water supplied through the water supply flow path P₀may flow to the second guide flow path P₂, and be guided to the second housing opening 12a-2 formed in the second inlet/outlet portion 12-2 of the second housing 100-2.

Water guided to the second housing opening 12a-2 may flow through the first flow hole 430a-2 and the second flow hole 430b-2 in the second housing 100-2. Water flowing through the first flow hole 430a-2 in the second housing 100-2 may pass through the second electrode module 220, and flow to the second flow hole 430b-2 in the second housing 100-2. For example, water flowing through the first flow hole 430a-2 in the second housing 100-2 may pass through the second electrode module 220 through the second ion exchange layer 222, and flow to the second flow hole 430b-2 in the second housing 100-2.

Water flowing through the second flow hole 430b-2 in the second housing 100-2 may flow along one surface of the distribution plate 400-2 in the second housing 100-2, and flow to the second housing connection opening 11a-2.

Water flowing to the second housing connection opening 11a-2 may be discharged to the intermediate guide 24.

Water discharged to the intermediate guide 24 may be guided to the first housing 100-1 through the second intermediate flow path P₂₁ formed by the intermediate guide 24. For example, water flowing through the second intermediate flow path P₂₁ may be introduced into the first housing connection opening 12a-1 formed in the second inlet/outlet portion 12-1 of the first housing 100-1.

Water introduced into the first housing connection opening 12a-1 may flow through the first flow hole 430a-1 in the first housing 100-1. Water flowing through the first flow hole 430a-1 in the first housing 100-1 may pass through the first electrode module 210, and flow to the second flow hole 430b-1 in the first housing 100-1. For example, water flowing through the first flow hole 430a-1 in the first housing 100-1 may pass through the first electrode module 210 through the first ion exchange layer 212, and flow to the second flow hole 430b-1 in the first housing 100-1.

Water flowing to the second flow hole 430b-1 in the first housing 100-1 may flow to the first housing opening 11a-1 through the second flow hole 430b-1 in the first housing 100-1.

Water flowing to the first housing opening 11a-1 may be discharged to the first inlet/outlet guide 23. Water discharged to the first inlet/outlet guide 23 may flow through the second water outlet flow path P₂₂.

In one or more embodiments, the at least one valve 60 may switch the direction of water, supplied through the water supply flow path P₀, to the upper side of the first electrode module 210 by connecting the water supply flow path P₀ and the first guide flow path P₁ and blocking the second guide flow path P₂.

For example, referring to FIG. 7, in a state where the direction of water supplied through the water supply flow path P₀ is toward the lower side of the second electrode module 220, the water supply valve 62 and the first inlet/outlet valve 63 may connect the water supply flow path P₀ and the first guide flow path P₁ by allowing water to flow from the water supply flow path P₀ to the first housing opening 11a-1. In addition, the water supply valve 62 and/or the second inlet/outlet valve 64 may block the second guide flow path P₂ by blocking water from flowing from the water supply flow path P₀ to the second housing opening 12a-2.

In one or more embodiments, the at least one valve 60 may switch the direction of water, supplied through the water supply flow path P₀, to the lower side of the second electrode module 220 by connecting the water supply flow path P₀ and the second guide flow path P₂ and blocking the first guide flow path P₁.

For example, referring to FIG. 8, in a state where the direction of water supplied through the water supply flow path P₀ is toward the lower side of the first electrode module 210, the water supply valve 62 and the second inlet/outlet valve 64 may connect the water supply flow path P₀ and the second guide flow path P₂ by allowing water to flow from the water supply flow path P₀ to the second housing opening 12a-2. In addition, the water supply valve 62 and/or the first inlet/outlet valve 63 may block the first guide flow path P₁ by blocking water from flowing from the water supply flow path P₀ to the first housing opening 11a-1.

FIG. 9 is a schematic diagram illustrating an internal configuration of an electrode module according to one or more embodiments.

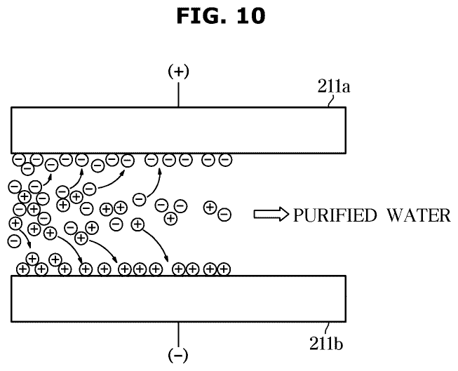

FIG. 10 is a diagram illustrating a deionization operation method by an electrode module according to one or more embodiments.

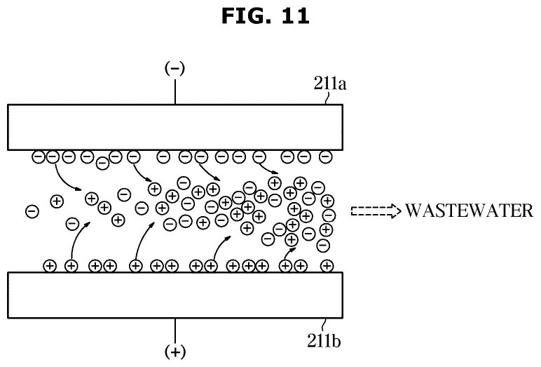

FIG. 11 is a diagram illustrating a regeneration operation method by an electrode module according to one or more embodiments.

Hereinafter, the deionization operation, regeneration operation, and descaling operation methods may be applied to any pair of adjacent electrodes of each of the plurality of electrode modules 200, including the first electrode module 210 and the second electrode module 220. However, for convenience of description, adjacent first electrodes (e.g., electrode 211a and electrode 211b) among the plurality of first electrodes 211a, including electrode 211a, electrode 211b, electrode 211c, and electrode 211d, (see FIG. 5) of the first electrode module 210 is described as an example.

Hereinafter, a pair of adjacent first electrodes 211a and 211b among the plurality of first electrodes 211a, including electrode 211a, electrode 211b, electrode 211c, and electrode 211d, (see FIG. 5) are described as the upper electrode 211a and the lower electrode 211b, respectively.

Referring to FIG. 9, one side of the upper electrode 211a and one side of the lower electrode 211b may function as opposite electrodes (i.e., a positive electrode and a negative electrode). Accordingly, an electric field may be formed between the upper electrode 211a and the lower electrode 211b.

The ion exchange layer 212 may be disposed between the upper electrode 211a and the lower electrode 211b.

The ion exchange layer 212 may include the anion exchange membrane 212a, the cation exchange membrane 212b, and the spacer 212c.

The anion exchange membrane 212a may allow only anions to pass through, while the cation exchange membrane 212b may allow only cations to pass through. The anion exchange membrane 212a may be attached to the upper electrode 211a, and the cation exchange membrane 212b may be attached to the lower electrode 211b. The anion exchange membrane 212a and the cation exchange membrane 212b may be omitted.

The spacer 212c may be disposed between the anion exchange membrane 212a and the cation exchange membrane 212b. The spacer 212c may allow water to pass therethrough. For example, the spacer 212c may include a mesh material.

Hereinafter, for convenience of description, the anion exchange membrane 212a, the cation exchange membrane 212b, and the spacer 212c are omitted in FIG. 10 and FIG. 11.

Referring to FIG. 10, by supplying power to the first electrode module 210, one side of the upper electrode 211a may function as a positive electrode, and one side of the lower electrode 211b may function as a negative electrode.

In this instance, when water moves between the spaced-apart upper electrode 211a and lower electrode 211b, ionic substances contained in the water may move to the upper electrode 211a and the lower electrode 211b due to electrical attraction. Accordingly, negatively charged ionic substances may be adsorbed on the upper electrode 211a, and positively charged ionic substances may be adsorbed on the lower electrode 211b. Accordingly, the water that has passed between the upper electrode 211a and the lower electrode 211b may contain no ionic substances or only a small amount of ionic substances.

As described above, removing ionic substances from water or purifying water to a certain concentration level of ionic substances by adsorbing the ionic substances on the electrodes may be referred to as a deionization operation.

A continuous deionization operation may result in accumulation of ionic substances on the upper electrode 211a and the lower electrode 211b, and thus an electric field may not be normally formed between the upper electrode 211a and the lower electrode 211b, which may reduce an efficiency of the deionization operation. A regeneration operation for maintaining the efficiency of the deionization operation is described below.

Referring to FIG. 11, power having a polarity opposite to the power supplied during the deionization operation may be supplied to the upper electrode 211a and the lower electrode 211b. For example, by supplying the first electrode module 210 with power having a polarity opposite to the power supplied during the deionization operation, one side of the upper electrode 211a may function as a negative electrode, and one side of the lower electrode 211b may function as a positive electrode. Accordingly, the ionic substances adsorbed on the upper electrode 211a and the lower electrode 211b may be desorbed from the upper electrode 211a and the lower electrode 211b.

In addition, in a case where no power is supplied to the first electrode module 210, an electric field is not formed between the upper electrode 211a and the lower electrode 211b, and thus the ionic substances adsorbed on the upper electrode 211a and the lower electrode 211b may be desorbed from the upper electrode 211a and the lower electrode 211b.

The ionic substances adsorbed on the upper electrode 211a and the lower electrode 211b may be desorbed from the upper electrode 211a and the lower electrode 211b and be discharged to the outside together with the water passing between the upper electrode 211a and the lower electrode 211b. As a result, the efficiency of the deionization operation may be maintained.

As described above, desorbing the ionic substances adsorbed on the electrodes to maintain the efficiency of the deionization operation may be referred to as a regeneration operation.

Repeating the deionization operation and the regeneration operation may lead to scale accumulation on the electrodes, reducing an efficiency of a water treatment process. For example, repeated deionization and regeneration operations may cause scale to accumulate on the upper electrode 211a and the lower electrode 211b, and thus an electric field is not normally formed between the upper electrode 211a and the lower electrode 211b, which may reduce the efficiency of the deionization operation.

Accordingly, a descaling operation for removing the scale accumulated on the electrodes requires to be performed.

The descaling operation may include passing acidic water between the electrodes to remove the scale accumulated on the electrodes. For example, the descaling operation may include passing acidic water through the upper electrode 211a and the lower electrode 211b to remove the scale accumulated on the upper electrode 211a and the lower electrode 211b.

During the descaling operation, the scale accumulated on the upper electrode 211a and the lower electrode 211b may be removed by the acidic water, and may be discharged to the outside together with the acidic water passing through the upper electrode 211a and the lower electrode 211b. Accordingly, the efficiency of the deionization operation may be maintained.

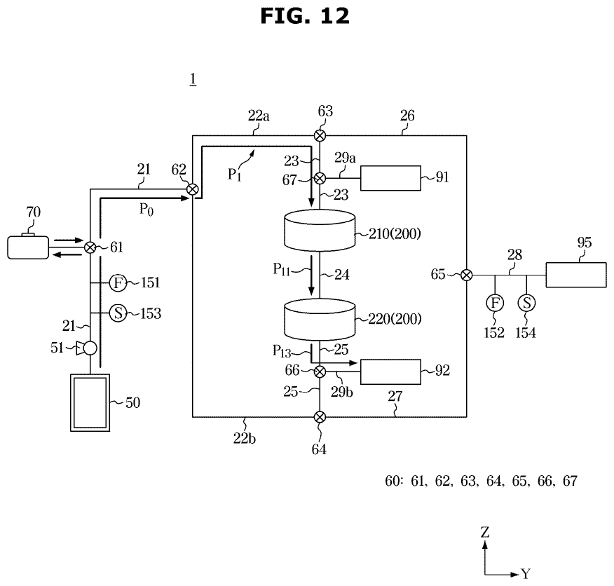

FIG. 12 illustrates an example of a direction of water supplied through a water supply flow path of a water treatment apparatus according to one or more embodiments.

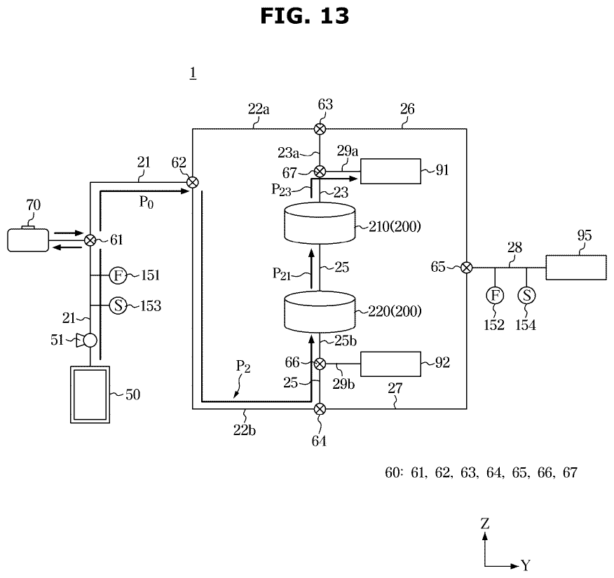

FIG. 13 illustrates an example different from FIG. 12 of a direction of water supplied through a water supply flow path of a water treatment apparatus according to one or more embodiments.

Referring to FIG. 12 and FIG. 13, the water treatment apparatus 1 may include a first drain flow path P₁₃.

The first drain flow path P₁₃ may include a flow path through which water discharged from the second electrode module 220 flows through the second inlet/outlet guide 25 and the second drain guide 29b.

The water treatment apparatus 1 may include a second drain flow path P₂₃.

The second drain flow path P₂₃ may include a flow path through which water discharged from the first electrode module 210 flows through the first inlet/outlet guide 23 and the first drain guide 29a.

In one or more embodiments, the at least one valve 60 may allow water to flow from the water supply flow path P₀ to the plurality of electrode modules 200, including the first electrode module 210 and the second electrode module 220, by bypassing the storage compartment 70.

For example, the descale valve 61 may block water from flowing from the water supply flow path P₀ to the storage compartment 70, thereby allowing external water (e.g., water supplied from the water source 50) to be supplied to the plurality of electrode modules 200, including the first electrode module 210 and the second electrode module 220, without passing through the storage compartment 70.

In one or more embodiments, the at least one valve 60 may allow water to flow from the water supply flow path P₀ to the plurality of electrode modules 200, including the first electrode module 210 and the second electrode module 220, via the storage compartment 70.

Water supplied through the water supply flow path P₀ may be used for a descaling operation by passing through the storage compartment 70. For example, in a case where water supplied through the water supply flow path P₀ passes through the storage compartment 70, a descaling agent stored in the storage compartment 70 dissolves in the water, making the water acidic. As a result, as the acidic water flows through the plurality of electrode modules 210 and 220, scale accumulated on the electrodes of each of the plurality of electrode modules 200, including the first electrode module 210 and the second electrode module 220, may be removed.

In a case where water supplied through the water supply flow path P₀ passes through the storage compartment 70, the controller 80 may switch a direction of the water, supplied through the water supply flow path P₀, to an upper side of the first electrode module 210 or a lower side of the second electrode module 220.

For example, referring to FIG. 12, in a case where water supplied through the water supply flow path P₀ is converted into acidic water by passing through the storage compartment 70, the controller 80 may allow the acidic water to be supplied to the upper side of the first electrode module 210 through the first guide flow path P₁. In this case, the controller 80 may control the second drain valve 66 to allow water that has passed through the first electrode module 210 and the second electrode module 220 to flow through the first drain flow path P₁₃.

As another example, referring to FIG. 13, in a case where water supplied through the water supply flow path P₀ is converted into acidic water by passing through the storage compartment 70, the controller 80 may allow the acidic water to be supplied to the lower side of the second electrode module 220 through the second guide flow path P₂. In this case, the controller 80 may control the first drain valve 67 to allow water that has passed through the second electrode module 220 and the first electrode module 210 to flow through the second drain flow path P₂₃.

An acidic concentration of the acidic water may differ depending on the direction of the acidic water supplied through the water supply flow path P₀. For example, in a case where acidic water supplied through the water supply flow path P₀ is supplied to the first electrode module 210 through the first guide flow path P₁, scale on the first electrode module 210 is removed, and then the acidic water discharged from the first electrode module 210 flows through the first intermediate flow path P₁₁, an acidic concentration of the acidic water flowing through the first guide flow path P₁ may be higher than that of the acidic water flowing through the first intermediate flow path P₁₁.

According to the disclosure, an efficiency of a descaling operation may be increased by switching the direction of acidic water supplied through the water supply flow path P₀.

For example, in a case where the amount of scale to be removed is relatively higher in the first electrode module 210 than in the second electrode module 220 among the first electrode module 210 and the second electrode module 220, the direction of the acidic water supplied through the water supply flow path P₀ may be switched to the upper side of the first electrode module 210 to remove a relatively larger amount of scale, thereby increasing the efficiency of the descaling operation.

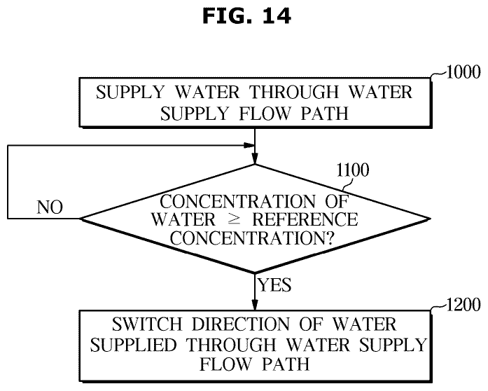

FIG. 14 is a flowchart illustrating an example of a method for controlling a water treatment apparatus according to one or more embodiments.

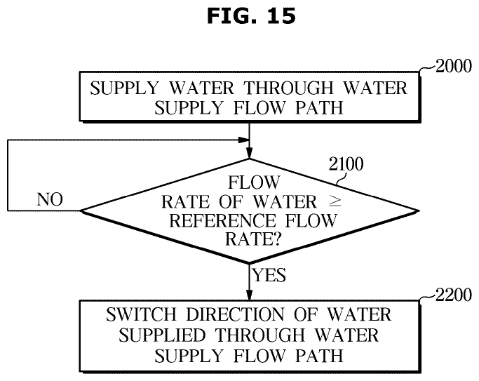

FIG. 15 is a flowchart illustrating an example of a method for controlling a water treatment apparatus according to one or more embodiments.

FIG. 16 is a diagram for illustrating an example of switching a direction of water supplied through a water supply flow path of a water treatment apparatus or supplying power to each of a plurality of electrode modules according to one or more embodiments.

A concentration of ionic substances contained in water supplied through the water supply flow path P₀ may be lowered while passing through a plurality of electrode modules. In addition, the amount of ionic substances processed by an electrode module to which water supplied through the water supply flow path P₀ first flows among the plurality of electrode modules may be relatively large. Processing ionic substances may include adsorbing ionic substances in water through a deionization operation.

For example, in a case where water supplied through the water supply flow path P₀ first flows to the first electrode module 210, the amount of ionic substances processed by the first electrode module 210 may be relatively larger than the amount of ionic substances processed by the second electrode module 220.

Accordingly, in a case where water supplied through the water supply flow path P₀ continuously flows into a specific electrode module first, a durability of the electrode module to which water first flows may be reduced.

According to the disclosure, the reduction in durability of the electrode module may be prevented by switching the direction of water supplied through the water supply flow path P₀ according to a predetermined condition.

Hereinafter, a method of switching the direction of water supplied through the water supply flow path P₀ according to a predetermined condition is described.

Hereinafter, as an example of switching the direction of water according to a predetermined condition, switching from an upper side of the first electrode module 210 to a lower side of the second electrode module 220 according to a predetermined condition is described. However, switching the direction of water according to a predetermined condition may also include switching from the lower side of the second electrode module 220 to the upper side of the first electrode module 210 according to a predetermined condition.

Referring to FIG. 14, the water treatment apparatus 1 may supply water through the water supply flow path P₀ (1000). For example, the water treatment apparatus 1 may control the pump 51 to allow water to be supplied to the first electrode module 210 and the second electrode module 220 through the water supply flow path P₀.

In one or more embodiments, the controller 80 may control the at least one valve 60 based on a concentration of water. The concentration of water may include a concentration of water supplied through the water supply flow path P₀ and/or a concentration of water that has passed through the first electrode module 210 and the second electrode module 220.

For example, referring to FIG. 16, in a state where a direction of water supplied through the water supply flow path P₀ is toward the upper side of the first electrode module 210, the controller 80 may control the at least one valve 60 to switch the direction of water supplied through the water supply flow path P₀, so as to allow water supplied through the water supply flow path P₀ to be introduced to the lower side of the second electrode module 220, based on the concentration of water being greater than or equal to a reference concentration (Yes in operation 1100 and operation 1200 in FIG. 14).

As another example, in a state where the direction of water supplied through the water supply flow path P₀ is toward the upper side of the first electrode module 210, the controller 80 may control the at least one valve 60 to switch the direction of water supplied through the water supply flow path P₀, so as to allow water supplied through the water supply flow path P₀ to be introduced to the lower side of the second electrode module 220, based on a concentration of water pre-measured during a predetermined period being greater than or equal to the reference concentration.

The concentration of water pre-measured during the predetermined period may include a concentration of water supplied through the water supply flow path P₀ measured before performing a deionization operation or measured during the deionization operation, or a concentration of water that has passed through the first electrode module 210 and the second electrode module 220.

In one or more embodiments, the controller 80 may supply a first power V1 and a second power V2 to the first electrode module 210 and the second electrode module 220, respectively, based on the direction of water supplied through the water supply flow path P₀ being toward the upper side of the first electrode module 210.

A magnitude Iv1I of the first power V1 supplied to the first electrode module 210 may be greater than a magnitude Iv2I of the second power V2 supplied to the second electrode module 220.

That is, the magnitude of power (e.g., the magnitude Iv1I of the first power V1) supplied to an electrode module to which water supplied through the water supply flow path P₀ first flows (e.g., the first electrode module 210) may be greater than the magnitude of power V2 (e.g., the magnitude Iv2I of the second power) supplied to an electrode module (the second electrode module 220) to which the water flows after passing through the electrode module (e.g., the first electrode module 210).

In the deionization operation, the controller 80 may adjust the power supplied to each of the electrode modules, such as the first electrode module 210 and the second electrode module 220, so that a positive magnitude (e.g., +1.4V) of the first power V1 supplied to the first electrode module 210 is greater than a positive magnitude (e.g., +1.2V) of the second power V2 supplied to the second electrode module 220, based on the direction of water supplied through the water supply flow path P₀ being toward the upper side of the first electrode module 210.

In a regeneration operation and/or a descaling operation, the controller 80 may adjust the power supplied to each of the electrode modules 210 and 220 so that a negative magnitude (e.g., −1.4V) of the first power V1 supplied to the first electrode module 210 is greater than a negative magnitude (e.g., −1.2V) of the second power V2 supplied to the second electrode module 220, based on the direction of water supplied through the water supply flow path P₀ being toward the upper side of the first electrode module 210.

A duty ratio of the first power V1 supplied to the first electrode module 210 may be greater than that of the second power V2 supplied to the second electrode module 220.

The duty ratio of the power may include a ratio of time during which power is supplied to each of the plurality of electrode modules 200, including the first electrode module 210 and the second electrode module 220, over a predetermined period of time.

For example, in a case where the predetermined period of time is a deionization operation time, the power supply 190 may continuously supply the first power V1 to the first electrode module 210 during the deionization operation time, and may supply the second power V2 to the second electrode module 220 for half of the deionization operation time.

For example, in a case where the predetermined period of time is a regeneration operation time, the power supply 190 may continuously supply the first power V1 to the first electrode module 210 during the regeneration operation time, and may supply the second power V2 to the second electrode module 220 for half of the regeneration operation time.

For example, in a case where the predetermined period of time is a descaling operation time, the power supply 190 may continuously supply the first power V1 to the first electrode module 210 during the descaling operation time, and may supply the second power V2 to the second electrode module 220 for half of the descaling operation time.

In one or more embodiments, the controller 80 may supply a third power V3 and a fourth power V4 to the first electrode module 210 and the second electrode module 220, respectively, based on the direction of water supplied through the water supply flow path P₀ being toward the lower side of the second electrode module 220.

A magnitude Iv3I of the third power V3 supplied to the first electrode module 210 may be smaller than a magnitude Iv4I of the fourth power V4 supplied to the second electrode module 220.

In the deionization operation, the controller 80 may adjust the power supplied to each of the electrode modules 210 and 220 so that a positive magnitude (e.g., +1.4V) of the fourth power V4 supplied to the second electrode module 220 is greater than a positive magnitude (e.g., +1.2V) of the third power V3 supplied to the first electrode module 210, based on the direction of water supplied through the water supply flow path P₀ being toward the lower side of the second electrode module 220.

In the regeneration operation and/or the descaling operation, the controller 80 may adjust the power supplied to each of the electrode modules 210 and 220 so that a negative magnitude (e.g., −1.4V) of the fourth power V4 supplied to the second electrode module 220 is greater than a negative magnitude (e.g., −1.2V) of the third power V3 supplied to the first electrode module 210, based on the direction of water supplied through the water supply flow path P₀ being toward the lower side of the second electrode module 220.

A duty ratio of the fourth power V4 supplied to the second electrode module 220 may be greater than that of the third power V3 supplied to the first electrode module 210.

In various embodiments, in a state where the direction of water supplied through the water supply flow path P₀ is toward the upper side of the first electrode module 210, the controller 80 may adjust the first power V1 supplied to the first electrode module 210.

In one or more embodiments, in a state where the direction of water supplied through the water supply flow path P₀ is toward the upper side of the first electrode module 210, the controller 80 may increase the magnitude Iv1I of the first power V1 supplied to the first electrode module 210, based on the concentration of water being greater than or equal to the reference concentration.

For example, in a state where the direction of water supplied through the water supply flow path P₀ is toward the upper side of the first electrode module 210, the controller 80 may increase the predetermined magnitude Iv1I of the first power V1 by a predetermined magnitude (e.g., +0.2V), based on the concentration of water being greater than or equal to the reference concentration.

In one or more embodiments, in a state where the direction of water supplied through the water supply flow path P₀ is toward the upper side of the first electrode module 210, the controller 80 may increase the duty ratio Iv1I of the first power V1 supplied to the first electrode module 210 based on the concentration of water being greater than or equal to the reference concentration.

For example, in a state where the direction of water supplied through the water supply flow path P₀ is toward the upper side of the first electrode module 210, the controller 80 may increase a time for supplying the first power V1 to the first electrode module 210 during the deionization operation, based on the concentration of water being greater than or equal to the reference concentration.

Referring to FIG. 15, an operation of supplying water through the water supply flow path P₀ in FIG. 15 (2000) may be the same as the operation of supplying water through the water supply flow path P₀ in FIG. 14 (1000 of FIG. 14).

In one or more embodiments, the controller 80 may control the at least one valve 60 based on a flow rate of water. The flow rate of water may include a flow rate of water supplied through the water supply flow path P₀ and/or a flow rate of water that has passed through the first electrode module 210 and the second electrode module 220.

For example, referring to FIG. 16, in a state where the direction of water supplied through the water supply flow path P₀ is toward the upper side of the first electrode module 210, the controller 80 may control the at least one valve 60 to switch the direction of water supplied through the water supply flow path P₀, so as to allow water supplied through the water supply flow path P₀ to be introduced to the lower side of the second electrode module 220, based on the flow rate of water being greater than or equal to a reference flow rate (Yes in operation 2100 and operation 2200 in FIG. 15).

As another example, in a state where the direction of water supplied through the water supply flow path P₀ is toward the lower side of the second electrode module 220, the controller 80 may control the at least one valve 60 to switch the direction of water supplied through the water supply flow path P₀, so as to allow water supplied through the water supply flow path P₀ to be introduced to the lower side of the second electrode module 220, based on a flow rate of water pre-measured during a predetermined period being greater than or equal to the reference flow rate.

The flow rate of water pre-measured during the predetermined period may include a flow rate of water supplied through the water supply flow path P₀ measured before performing a water treatment process (e.g., deionization operation, regeneration operation, and descaling operation) or measured during the water treatment process, or a flow rate of water that has passed through the first electrode module 210 and the second electrode module 220.

As another example, in a state where the direction of water supplied through the water supply flow path P₀ is toward the lower side of the second electrode module 220, the controller 80 may control the at least one valve 60 to switch the direction of water supplied through the water supply flow path P₀, so as to allow water supplied through the water supply flow path P₀ to be introduced to the lower side of the second electrode module 220, based on a cumulative flow rate of water measured for a predetermined number of times of performing the water treatment process (e.g., deionization operation, regeneration operation, and descaling operation) being greater than or equal to the reference flow rate.

In one or more embodiments, in a state where the direction of water supplied through the water supply flow path P₀ is toward the upper side of the first electrode module 210, the controller 80 may increase the magnitude Iv1I of the first power V1 supplied to the first electrode module 210, based on the flow rate of water being greater than or equal to the reference flow rate.

For example, in a state where the direction of water supplied through the water supply flow path P₀ is toward the upper side of the first electrode module 210, the controller 80 may increase the predetermined magnitude Iv1I of the first power V1 by a predetermined magnitude (e.g., +0.2V), based on the flow rate of water being greater than or equal to the reference flow rate.

In one or more embodiments, in a state where the direction of water supplied through the water supply flow path P₀ is toward the upper side of the first electrode module 210, the controller 80 may increase the duty ratio Iv1I of the first power V1 supplied to the first electrode module 210 based on the flow rate of water being greater than or equal to the reference flow rate.

For example, in a state where the direction of water supplied through the water supply flow path P₀ is toward the upper side of the first electrode module 210, the controller 80 may increase a time for supplying the first power V1 to the first electrode module 210 during the deionization operation, based on the flow rate of water being greater than or equal to the reference flow rate.

According to the disclosure, a water treatment apparatus may include: a first electrode module including a plurality of first electrodes; a second electrode module including a plurality of second electrodes and arranged adjacent to a first side of the first electrode module; a water supply flow path; and a valve configured to switch a direction of water, supplied through the water supply flow path, to a second side, opposite to the first side of the first electrode module, or to a first side of the second electrode module.

The water treatment apparatus may further include a housing configured to accommodate the first electrode module and the second electrode module, wherein the housing may include a first opening provided on the second side of the first electrode module and a second opening provided on the first side of the second electrode module.

In addition, the water treatment apparatus may further include: a first guide flow path configured to guide water, supplied through the water supply flow path, to the first opening; and a second guide flow path configured to guide water, supplied through the water supply flow path, to the second opening, wherein the valve may be configured to switch the direction of water, supplied through the water supply flow path, to the second side of the first electrode module by connecting the water supply flow path and the first guide flow path and blocking the second guide flow path, and switch the direction of water, supplied through the water supply flow path, to the first side of the second electrode module by connecting the water supply flow path and the second guide flow path and blocking the first guide flow path.

In addition, the water treatment apparatus may further include at least one electrode terminal disposed between the first electrode module and the second electrode module inside the housing.

In addition, the water treatment apparatus may further include: a first housing configured to accommodate the first electrode module; and a second housing configured to accommodate the second electrode module, wherein the first housing may include a first housing opening provided on the second side of the first electrode module and a first housing connection opening provided on the first side of the first electrode module, and the second housing may include a second housing opening provided on the first side of the second electrode module and a second housing connection opening provided on the second side of the second electrode module.

In addition, the water treatment apparatus may further include: a first guide flow path configured to guide water, supplied through the water supply flow path, to the first housing opening; a second guide flow path configured to guide water, supplied through the water supply flow path, to the second housing opening; and an intermediate flow path configured to connect the first housing connection opening and the second housing connection opening, wherein the valve may be configured to: switch the direction of water, supplied through the water supply flow path, to the second side of the first electrode module by connecting the water supply flow path and the first guide flow path and blocking the second guide flow path, and switch the direction of water, supplied through the water supply flow path, to the first side of the second electrode module by connecting the water supply flow path and the second guide flow path and blocking the first guide flow path.

In addition, the water treatment apparatus may further include a storage compartment connected to the water supply flow path and configured to store a descaling agent, wherein the valve may be configured to switch the direction of water supplied through the water supply flow path so as to allow water to flow from the water supply flow path to the first electrode module and the second electrode module via the storage compartment or by bypassing the storage compartment.

In addition, the water treatment apparatus may further include a controller configured to control the valve based on at least one of a concentration or a flow rate of water supplied through the water supply flow path.

In a state in which the direction of water supplied through the water supply flow path is toward the second side of the first electrode module, the controller may be configured to control the valve to switch the direction of water, supplied through the water supply flow path, to the first side of the second electrode module, based on the concentration of water supplied through the water supply flow path being greater than or equal to a reference concentration.

In a state in which the direction of water supplied through the water supply flow path is toward the second side of the first electrode module, the controller may be configured to control the valve to switch the direction of water, supplied through the water supply flow path, to the first side of the second electrode module, based on the flow rate of water supplied through the water supply flow path being greater than or equal to a reference flow rate.

In addition, the water treatment apparatus may further include a controller configured to control the valve based on at least one of a concentration or a flow rate of water that has passed through the first electrode module and the second electrode module.

In a state in which the direction of water supplied through the water supply flow path is toward the second side of the first electrode module, the controller may be configured to: control the valve to switch the direction of water, supplied through the water supply flow path, to the first side of the second electrode module, based on the concentration of water that has passed through the first electrode module and the second electrode module being greater than or equal to a reference concentration, and control the valve to switch the direction of water, supplied through the water supply flow path, to the first side of the second electrode module, based on the flow rate of water that has passed through the first electrode module and the second electrode module being greater than or equal to a reference flow rate.

In addition, the water treatment apparatus may further include a controller configured to supply a first power and a second power to the first electrode module and the second electrode module, respectively, based on the direction of water supplied through the water supply flow path being toward the second side of the first electrode module, and supply a third power and a fourth power to the first electrode module and the second electrode module, respectively, based on the direction of water supplied through the water supply flow path being toward the first side of the second electrode module, wherein a magnitude of the first power may be larger than a magnitude of the second power, and a magnitude of the third power may be smaller than a magnitude of the fourth power.

In addition, the water treatment apparatus may further include: a controller configured to supply a first power and a second power to the first electrode module and the second electrode module, respectively, based on the direction of water supplied through the water supply flow path being toward the second side of the first electrode module, and supply a third power and a fourth power to the first electrode module and the second electrode module, respectively, based on the direction of water supplied through the water supply flow path being toward the first side of the second electrode module, wherein a duty ratio of the first power may be greater than a duty ratio of the second power, and a duty ratio of the third power may be less than a duty ratio of the fourth power.

According to the disclosure, a water treatment apparatus may include: a first electrode module including a plurality of first electrodes; a second electrode module including a plurality of second electrodes and arranged adjacent to a first side of the first electrode module; a water supply flow path; a power supply configured to supply a first power and a second power to the first electrode module and the second electrode module, respectively; a valve; and a controller, wherein, in a state in which a direction of water supplied through the water supply flow path is toward a second side opposite to the first side of the first electrode module, the controller may be configured to: switch the direction of water, supplied through the water supply flow path, to a first side of the second electrode module, or adjust the first power supplied to the first electrode module.

In a state in which the direction of water supplied through the water supply flow path is toward the second side of the first electrode module, the controller may be configured to increase at least one of a magnitude or a duty ratio of a first power supplied to the first electrode module, based on a concentration of water supplied through the water supply flow path being greater than or equal to a reference concentration.

In a state in which the direction of water supplied through the water supply flow path is toward the second side of the first electrode module, the controller may be configured to increase at least one of a magnitude or a duty ratio of a first power supplied to the first electrode module, based on a flow rate of water supplied through the water supply flow path being greater than or equal to a reference flow rate.

In a state in which the direction of water supplied through the water supply flow path is toward the second side of the first electrode module, the controller may be configured to increase at least one of a magnitude or a duty ratio of a first power supplied to the first electrode module, based on a concentration of water that has passed through the first electrode module and the second electrode module being greater than or equal to a reference concentration.

In a state in which the direction of water supplied through the water supply flow path is toward the second side of the first electrode module, the controller may be configured to increase at least one of a magnitude or a duty ratio of a first power supplied to the first electrode module, based on a flow rate of water that has passed through the first electrode module and the second electrode module being greater than or equal to a reference flow rate.

According to the disclosure, in a method for controlling a water treatment apparatus including a first electrode module including a plurality of first electrodes; a second electrode module including a plurality of second electrodes and arranged adjacent to a first side of the first electrode module; a water supply flow path; and a valve configured to switch a direction of water, supplied through the water supply flow path, to a second side, opposite to the first side of the first electrode module, or to a first side of the second electrode module, the method may include controlling the valve based on at least one of a concentration or a flow rate of water supplied through the water supply flow path.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

The computer-readable recording medium may be provided in the form of a non-transitory recording medium. Here, when a recording medium is referred to as “non-transitory”, it may be understood that the recording medium is tangible and does not include a signal (e.g., an electromagnetic wave), but rather that data is semi-permanently or temporarily stored in the recording medium. For example, a “non-transitory recording medium” may include a buffer in which data is temporarily stored.

The method according to the various embodiments disclosed herein may be provided in a computer program product. The computer program product may be traded between a seller and a buyer as a product. The computer program product may be distributed in the form of a machine-readable recording medium (e.g., compact disc read only memory (CD-ROM)), or may be distributed (e.g., download or upload) through an application store (e.g., Play Store™) online or directly between two user devices (e.g., smartphones). In the case of online distribution, at least a portion of the computer program product (e.g., downloadable app) may be stored at least semi-permanently or may be temporarily generated in a recording medium, such as a memory of a server of a manufacturer, a server of an application store, or a relay server.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

What is claimed is:

1. A water treatment apparatus comprising:
a first electrode module comprising a plurality of first electrodes;
a second electrode module adjacent to a first side of the first electrode module, and comprising a plurality of second electrodes;
a water supply flow path; and
a valve configured to switch a direction of water, supplied through the water supply flow path, from the water supply flow path to a second side, opposite to the first side of the first electrode module, and from the water supply flow path to a first side of the second electrode module.

2. The water treatment apparatus of claim 1, further comprising:
a housing accommodating the first electrode module and the second electrode module,
wherein the housing comprises a first opening provided on the second side of the first electrode module, and a second opening provided on the first side of the second electrode module.

3. The water treatment apparatus of claim 2, further comprising:
a first guide flow path configured to guide the water, supplied through the water supply flow path, to the first opening; and
a second guide flow path configured to guide the water, supplied through the water supply flow path, to the second opening,
wherein the valve is further configured to:
switch the direction of the water, supplied through the water supply flow path, to the second side of the first electrode module by connecting the water supply flow path and the first guide flow path and blocking the second guide flow path, and
switch the direction of the water, supplied through the water supply flow path, to the first side of the second electrode module by connecting the water supply flow path and the second guide flow path and blocking the first guide flow path.

4. The water treatment apparatus of claim 2, further comprising:
at least one electrode terminal between the first electrode module and the second electrode module inside the housing.

5. The water treatment apparatus of claim 1, further comprising:
a first housing accommodating the first electrode module; and
a second housing accommodating the second electrode module,
wherein the first housing comprises a first housing opening on the second side of the first electrode module, and a first housing connection opening on the first side of the first electrode module, and
wherein the second housing comprises a second housing opening on the first side of the second electrode module, and a second housing connection opening on the second side of the second electrode module.

6. The water treatment apparatus of claim 5, further comprising:
a first guide flow path configured to guide the water, supplied through the water supply flow path, to the first housing opening;
a second guide flow path configured to guide the water, supplied through the water supply flow path, to the second housing opening; and
an intermediate flow path configured to connect the first housing connection opening and the second housing connection opening,
wherein the valve is further configured to:
switch the direction of the water, supplied through the water supply flow path, from the water supply flow path to the second side of the first electrode module by connecting the water supply flow path and the first guide flow path and blocking the second guide flow path, and
switch the direction of the water, supplied through the water supply flow path, from the water supply flow path to the first side of the second electrode module by connecting the water supply flow path and the second guide flow path and blocking the first guide flow path.

7. The water treatment apparatus of claim 1, further comprising:
a storage compartment connected to the water supply flow path and configured to store a descaling agent,
wherein the valve is further configured to switch the direction of the water supplied through the water supply flow path from the water supply flow path to any of the first electrode module and the second electrode module from the storage compartment and to bypass the storage compartment.

8. The water treatment apparatus of claim 1, further comprising:
a controller configured to control the valve based on at least one of a concentration of the water supplied through the water supply flow path and a flow rate of the water supplied through the water supply flow path.

9. The water treatment apparatus of claim 8, wherein the controller is further configured to:
in a state in which the direction of the water supplied through the water supply flow path is toward the second side of the first electrode module, control the valve to switch the direction of the water, supplied through the water supply flow path, to the first side of the second electrode module, based on the concentration of the water supplied through the water supply flow path being greater than or equal to a reference concentration.

10. The water treatment apparatus of claim 8, wherein the controller is further configured to:
in a state in which the direction of the water supplied through the water supply flow path is toward the second side of the first electrode module, control the valve to switch the direction of the water, supplied through the water supply flow path, to the first side of the second electrode module, based on the flow rate of the water supplied through the water supply flow path being greater than or equal to a reference flow rate.

11. The water treatment apparatus of claim 1, further comprising:
a controller configured to control the valve based on at least one of a concentration of the water that has passed through the first electrode module and the second electrode module and a flow rate of the water that has passed through the first electrode module and the second electrode module.

12. The water treatment apparatus of claim 11, wherein the controller is further configured to, in a state in which the direction of water supplied through the water supply flow path is toward the second side of the first electrode module:
control the valve to switch the direction of the water, supplied through the water supply flow path, to the first side of the second electrode module, based on the concentration of the water that has passed through the first electrode module and the second electrode module being greater than or equal to a reference concentration, and
control the valve to switch the direction of the water, supplied through the water supply flow path, to the first side of the second electrode module, based on the flow rate of the water that has passed through the first electrode module and the second electrode module being greater than or equal to a reference flow rate.

13. The water treatment apparatus of claim 1, further comprising:
a controller configured to:
supply a first power to the first electrode module and supply a second power to the second electrode module, based on the direction of the water supplied through the water supply flow path being from the water supply flow path to the second side of the first electrode module, and
supply a third power to the first electrode module and supply a fourth power to the second electrode module, based on the direction of the water supplied through the water supply flow path being from the water supply flow path to the first side of the second electrode module,
wherein a magnitude of the first power is larger than a magnitude of the second power, and a magnitude of the third power is smaller than a magnitude of the fourth power.

14. The water treatment apparatus of claim 1, further comprising:
a controller configured to:
supply a first power to the first electrode module and supply a second power to the second electrode module, based on the direction of the water supplied through the water supply flow path being from the water supply flow path to the second side of the first electrode module, and
supply a third power to the first electrode module and supply a fourth power to the second electrode module, based on the direction of the water supplied through the water supply flow path being from the water supply flow path to the first side of the second electrode module,
wherein a duty ratio of the first power is greater than a duty ratio of the second power, and a duty ratio of the third power is less than a duty ratio of the fourth power.

15. A water treatment apparatus, comprising:
a first electrode module comprising a plurality of first electrodes;
a second electrode module adjacent to a first side of the first electrode module and comprising a plurality of second electrodes;
a water supply flow path;
a power supply configured to supply a first power to the first electrode module and supply a second power to the second electrode module;
a valve; and
a controller,
wherein the controller is configured to, in a state in which a direction of water supplied through the water supply flow path is toward a second side opposite to the first side of the first electrode module:
switch the direction of water, supplied through the water supply flow path, to a first side of the second electrode module, or
adjust the first power supplied to the first electrode module.

16. A water treatment apparatus comprises:
a first electrode module comprising a plurality of first electrodes;
a second electrode module adjacent to a first side of the first electrode module and comprising a plurality of second electrodes;
a water supply flow path;
a power supply configured to supply a first power and a second power to the first electrode module and the second electrode module, respectively;
a valve; and
a controller configured to, in a state in which a direction of water supplied through the water supply flow path is toward a second side opposite to the first side of the first electrode module:
switch the direction of water, supplied through the water supply flow path, from the water supply flow path to a first side of the second electrode module, and
adjust the first power supplied to the first electrode module.

17. The water treatment apparatus of claim 16, wherein the controller is further configured to, in a state in which the direction of water supplied through the water supply flow path is toward the second side of the first electrode module, increase at least one of a magnitude or a duty ratio of a first power supplied to the first electrode module, based on a concentration of water supplied through the water supply flow path being greater than or equal to a reference concentration.

18. The water treatment apparatus of claim 16, wherein the controller is further configured to, in a state in which the direction of water supplied through the water supply flow path is toward the second side of the first electrode module, increase at least one of a magnitude or a duty ratio of a first power supplied to the first electrode module, based on a flow rate of water supplied through the water supply flow path being greater than or equal to a reference flow rate.

19. The water treatment apparatus of claim 16, wherein the controller is further configured to:
in a state in which the direction of water supplied through the water supply flow path is toward the second side of the first electrode module, increase at least one of a magnitude or a duty ratio of a first power supplied to the first electrode module, based on a concentration of water that has passed through the first electrode module and the second electrode module being greater than or equal to a reference concentration, and
in a state in which the direction of water supplied through the water supply flow path is toward the second side of the first electrode module, increase at least one of a magnitude or a duty ratio of a first power supplied to the first electrode module, based on a flow rate of water that has passed through the first electrode module and the second electrode module being greater than or equal to a reference flow rate.

20. A method for controlling a water treatment apparatus comprising a first electrode module including a plurality of first electrodes, a second electrode module including arranged adjacent to a first side of the first electrode module and a plurality of second electrodes; a water supply flow path, and a valve configured to switch a direction of water supplied through the water supply flow path, the method comprising:
controlling the valve to switch the direction of water supplied through the water supply flow path, from the water supply path to a second side, opposite to the first side of the first electrode module; and
controlling the valve to switch the direction of water supplied through the water supply flow path, from the water supply path to a first side of the second electrode module, based on at least one of a concentration or a flow rate of water supplied through the water supply flow path.
